(19) United States
(12) Patent Application Publication
(10) Pub. No.: US 2026/0184074 A1
(43) Pub. Date: Jul. 2, 2026

(54) LIQUID EJECTING HEAD AND LIQUID EJECTING APPARATUS

(71) Applicant: SEIKO EPSON CORPORATION, Tokyo (JP)

(72) Inventors: Ichiro YONEYAMA, SHIOJIRI-SHI (JP); Haruhisa UEZAWA, SHIOJIRI-SHI (JP); Shuichi KOGANEHIRA, MATSUMOTO-SHI (JP); Kenji SATO, SHIOJIRI-SHI (JP)

(21) Appl. No.: 19/428,432

(22) Filed: Dec. 22, 2025

(30) Foreign Application Priority Data
Dec. 26, 2024 (JP) 2024-230450

(51) Int. Cl. B41J 2/14; B41J 2/20; B41J 29/00; G01V 3/02

(52) U.S. Cl. CPC B41J 2/14233; B41J 2/20; B41J 29/00; G01V 3/02; B41J 2002/14306

(57) ABSTRACT

A liquid ejecting head includes: a first flow path that communicates with one or more nozzles among a plurality of nozzles; a first bonding portion A that defines an inner wall of the first flow path and that is provided to surround the first flow path; a first bonding portion B that is provided to surround the first bonding portion A; and a first detection portion A for detecting a state in which liquid passes beyond the first bonding portion A but does not pass beyond the first bonding portion B.

The present application is based on, and claims priority from JP Application Serial Number 2024-230450, filed Dec. 26, 2024, the disclosure of which is hereby incorporated by reference herein in its entirety.

### BACKGROUND

### 1. Technical Field

The present disclosure relates to a liquid ejecting head and a liquid ejecting apparatus.

### 2. Related Art

In the related art, a liquid ejecting head that ejects liquid such as ink from a nozzle is widely used. For example, JP-A-2023-100338 discloses that a plurality of flow path members constituting a flow path of a liquid ejecting head are joined to each other with an adhesive, thereby liquid-tightly coupling flow paths formed in the plurality of joined flow path members.

The adhesive joining the flow path members deteriorates upon contact with liquid flowing through the flow path, and the liquid in the flow path may leak out from a bonded portion to an outside of the flow path members. However, in the related art mentioned above, there is a problem in that a user of the liquid ejecting head cannot determine when the liquid ejecting head should be replaced.

### SUMMARY

According to a preferred aspect of the present disclosure, there is provided a liquid ejecting head including: a plurality of nozzles that eject liquid; a first flow path that communicates with one or more nozzles among the plurality of nozzles; a first bonding portion A that defines an inner wall of the first flow path and that is provided to surround the first flow path; a first bonding portion B that is provided to surround the first bonding portion A; and a first detection portion A for detecting a state in which the liquid passes beyond the first bonding portion A but does not pass beyond the first bonding portion B.

According to a preferred aspect of the present disclosure, there is provided a liquid ejecting apparatus including: the liquid ejecting head; an acquisition section that acquires state information regarding a state of the first detection portion A; and an estimation section that estimates a degree of deterioration of the first bonding portion A based on the state information.

### BRIEF DESCRIPTION OF THE DRAWINGS

FIG. 1 is a schematic diagram showing a configuration example of an ink jet system according to a first embodiment.

FIG. 2 is a diagram showing a configuration of a processing apparatus.

FIG. 3 is a block diagram showing a configuration example of an ink jet printer.

FIG. 4 is a configuration diagram of the ink jet printer.

FIG. 5 is an exploded perspective view of a liquid ejecting head.

FIG. 6 is a cross-sectional view of the liquid ejecting head taken along line VI-VI in FIG. 5.

FIG. 7 is an enlarged view of a vicinity of an ink hole shown in FIG. 6.

FIG. 8 is a cross-sectional view of a head unit taken along an X-axis direction through a wiring hole.

FIG. 9 is a plan view schematically showing an inside of the head unit.

FIG. 10 is a plan view exemplifying an in-structure flow path.

FIG. 11 is a side view of an in-structure supply flow path and an in-structure discharge flow path.

FIG. 12 is a side view of an in-structure supply flow path and an in-structure discharge flow path.

FIG. 13 is a view illustrating a detection mechanism.

FIG. 14 is a view illustrating the detection mechanism.

FIG. 15 is a view illustrating the detection mechanism.

FIG. 16 is a diagram showing a function of the ink jet system.

FIG. 17 is a diagram showing a flowchart showing an operation of the ink jet system.

FIG. 18 is a block diagram showing a configuration example of an ink jet printer in a second embodiment.

FIG. 19 is a view illustrating a first bonding portion.

FIG. 20 is a diagram showing a flowchart showing an operation of the ink jet system in the second embodiment.

FIG. 21 is a block diagram showing a configuration example of an ink jet printer in a third embodiment.

FIG. 22 is a view illustrating a detection mechanism.

FIG. 23 is a view illustrating a detection mechanism in a first modification example.

FIG. 24 is a view illustrating detection mechanisms in a second modification example.

FIG. 25 is a block diagram showing a configuration example of an ink jet printer in a third modification example.

FIG. 26 is a view illustrating detection mechanisms.

FIG. 27 is a view illustrating the detection mechanisms.

FIG. 28 is a view illustrating a first bonding portion in a fourth modification example.

FIG. 29 is a view illustrating the first bonding portion in the fourth modification example.

FIG. 30 is a view illustrating a detection mechanism in a fifth modification example.

### DESCRIPTION OF EMBODIMENTS

Hereinafter, embodiments for implementing the present disclosure will be described with reference to the drawings. Note that, in the drawings, dimensions and scales of each portion are made different from actual ones as appropriate. In addition, since embodiments to be described below are preferred specific examples of the present disclosure, various technically preferable limitations are imposed. However, the scope of the present disclosure is not limited to these embodiments unless there is a description in the following description that particularly limits the present disclosure.

Hereinafter, for convenience of description, one direction along an X-axis from any point will be referred to as an X1 direction, and a direction opposite to the X1 direction will be referred to as an X2 direction. The X1 direction and the X2 direction are collectively referred to as a direction along the X-axis. Similarly, directions opposite to each other along a Y-axis from any point will be referred to as a Y1 direction and a Y2 direction, and directions opposite to each other along a Z-axis from any point will be referred to as a Z1 direction and a Z2 direction. The Y1 direction and the Y2 direction are collectively referred to as a direction along the Y-axis. The Z1 direction and the Z2 direction are collectively referred to as a direction along the Z-axis. The direction along the X-axis and the direction along the Y-axis are orthogonal to each other. The direction along the X-axis and the direction along the Z-axis are orthogonal to each other. The direction along the Y-axis and the direction along the Z-axis are orthogonal to each other. An X-Y plane including the X-axis and the Y-axis corresponds to a horizontal plane. The Z-axis is an axis along a vertical direction, the Z1 direction corresponds to an upper side in the vertical direction, and the Z2 direction corresponds to a lower side in the vertical direction. Additionally, viewing in the direction along the Z-axis may be referred to as “plan view”.

### 1. First Embodiment

### 1-1. Overview of Ink Jet System SYS

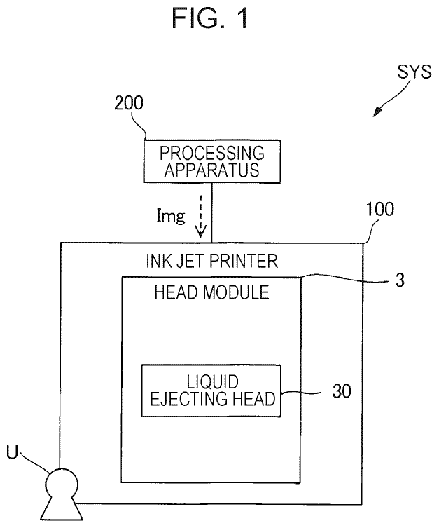

FIG. 1 is a schematic diagram showing a configuration example of an ink jet system SYS according to a first embodiment. The ink jet system SYS is a system that provides a service of forming an image on a medium PP, which will be described below, by using an ink jet method. The ink jet system SYS includes an ink jet printer 100 and a processing apparatus 200.

Here, the ink jet printer 100 is an apparatus provided by a manufacturer of the ink jet printer 100. The ink jet printer 100 is a liquid ejecting apparatus that ejects ink, which is an example of liquid. The manufacturer of the ink jet printer 100 is a company that manufactures the ink jet printer 100. The manufacturer of the ink jet printer 100 may be referred to as a “printer manufacturer”. A liquid ejecting head 30 incorporated into the ink jet printer 100 is provided by a manufacturer of the liquid ejecting head 30. The manufacturer of the liquid ejecting head 30 is a company that manufactures the liquid ejecting head 30. Hereinafter, the manufacturer of the liquid ejecting head 30 may be referred to as a “head manufacturer”. The printer manufacturer receives provision of the liquid ejecting head 30 from the head manufacturer and manufactures the ink jet printer 100 by incorporating the provided liquid ejecting head 30 into the ink jet printer 100. The ink jet printer 100 is an example of a “liquid ejecting apparatus”.

FIG. 1 shows a user U who uses the ink jet printer 100. As the user U, for example, when an operator belonging to the printer manufacturer uses the ink jet printer 100, this operator is the user U. In addition, for example, when a third party who receives the provision of the ink jet printer 100 from the printer manufacturer uses the ink jet printer 100, this third party is the user U. The user U uses the processing apparatus 200 in addition to the ink jet printer 100.

The ink jet printer 100 receives image data Img indicating an image from the processing apparatus 200. The ink jet printer 100 forms an image based on the image data Img on the medium PP. Hereinafter, a process of forming an image on the medium PP may be referred to as a “printing process”.

The ink jet printer 100 includes one head module 3 including one liquid ejecting head 30.

The processing apparatus 200 is a computer such as a desktop type or a notebook type. The processing apparatus 200 may be provided as a part of the ink jet printer 100.

### 1-2. Concerning Failure of Liquid Ejecting Head 30

The liquid ejecting head 30 provided in the ink jet printer 100 may fail because of aging deterioration or the like. One reason for failure of the liquid ejecting head 30 is that a bonding portion that bonds two flow path members constituting a flow path in the liquid ejecting head 30 to liquid-tightly couple flow paths of the two flow path members may come into contact with ink for a long period of time, thereby undergoing either or both of deterioration due to wear caused by a flow velocity or the like and deterioration due to elution of an adhesive into the ink caused by attack by the ink. Consequently, the flow paths of the two flow path members cannot be liquid-tightly coupled, and ink may leak out of the flow path from a location where liquid-tight coupling is no longer possible. Hereinafter, a case where the adhesive can no longer seal a gap between the flow paths of the two flow path members may be referred to as “seal failure”. When seal failure occurs, ink may leak out of the flow path from a location where the seal failure occurs. When ink leaks out of the flow path, the ink may adhere to an electronic circuit in the liquid ejecting head 30 to cause failure, or an inside or a periphery of the ink jet printer 100 may become contaminated with the ink.

Accordingly, there is provided a liquid ejecting head 30 capable of detecting a sign of ink leakage from the liquid ejecting head 30, before the liquid ejecting head 30 fails because of ink leaking out of the flow path from the location where seal failure occurs. The sign of ink leakage from the liquid ejecting head 30 includes that ink will soon leak from the liquid ejecting head 30, and estimation of the lifetime of the liquid ejecting head 30, that is, estimation of a time point at which ink will leak from the liquid ejecting head 30.

### 1-3. Configuration of Processing Apparatus 200

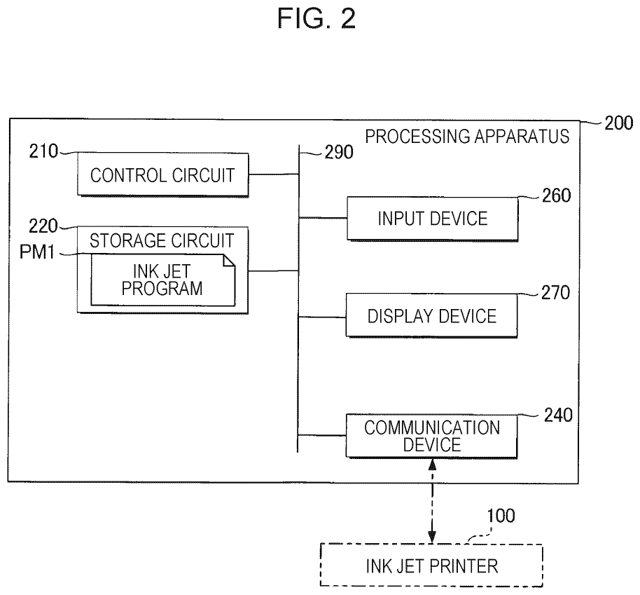

FIG. 2 is a diagram showing a configuration of the processing apparatus 200. The processing apparatus 200 includes a control circuit 210, a storage circuit 220, a communication device 240, an input device 260, and a display device 270. The control circuit 210, the storage circuit 220, the communication device 240, the input device 260, and the display device 270 are mutually connected by a bus 290 for information communication.

The control circuit 210 includes, for example, one or more processors, such as a central processing unit (CPU). The control circuit 210 may include a programmable logic device such as a field-programmable gate array (FPGA) instead of the CPU or in addition to the CPU.

The storage circuit 220 is configured with a magnetic storage device, a flash ROM, or the like. The storage circuit 220 is readable by the control circuit 210 and stores a plurality of programs including an ink jet program PM1 executed by the control circuit 210, various kinds of information used by the control circuit 210, and the like. The storage circuit 220 includes, for example, semiconductor memories of one or both of one or more volatile memories, such as a RAM, and one or more non-volatile memories, such as a ROM, an EEPROM, or a PROM. The ink jet program PM1 is, for example, a program for generating the image data Img.

The communication device 240 is a circuit that can communicate with the ink jet printer 100. For example, the communication device 240 is a network card, such as a Universal Serial Bus (USB) or Bluetooth. USB and Bluetooth are registered trademarks.

The input device 260 is a device that outputs operation information corresponding to an operation of the user U. The input device 260 is, for example, a mouse and a keyboard.

The display device 270 displays an image indicating some kind of information to the user U. The display device 270 is an organic electro-luminescence (EL) display, a light emitting diode (LED) display, and a liquid crystal display (LCD). Additionally, the input device 260 and the display device 270 may be configured integrally. A configuration in which the input device 260 and the display device 270 are integral is, for example, a touch panel.

### 1-4. Overview of Ink Jet Printer 100

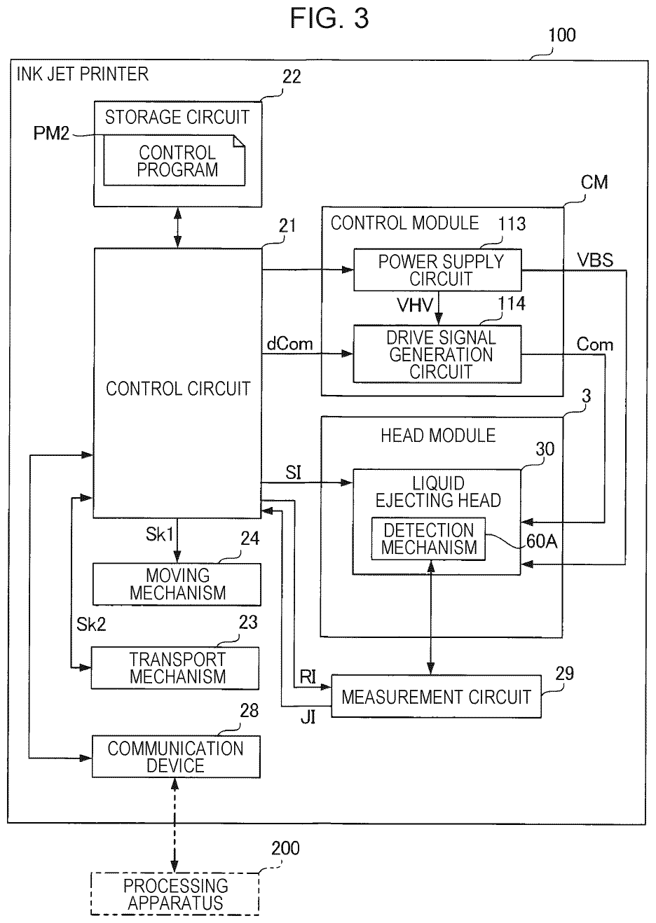

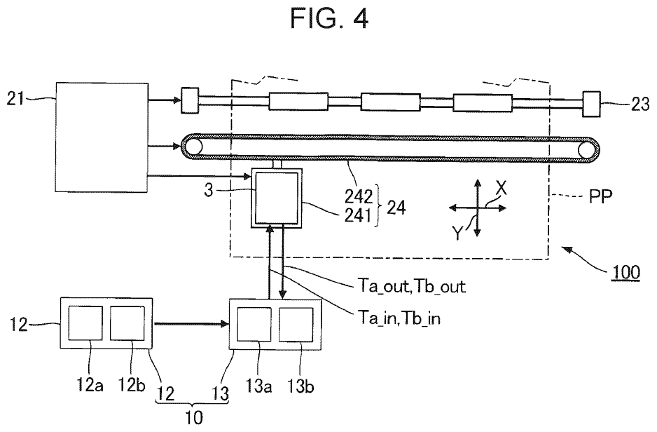

FIG. 3 is a block diagram showing a configuration example of the ink jet printer 100. FIG. 4 is a configuration diagram of the ink jet printer 100. The ink jet printer 100 shown in FIG. 4 is an ink jet type printing apparatus that ejects ink as droplets onto the medium PP. The ink is an example of “liquid”. The medium PP is, for example, printing paper. However, the medium PP is not limited to printing paper and may be, for example, a printing target of any material, such as a resin film or fabric.

As shown in FIGS. 3 and 4, the ink jet printer 100 includes a control module CM, a liquid supply system 10, a control circuit 21, a storage circuit 22, a transport mechanism 23, a moving mechanism 24, the head module 3, a communication device 28, and a measurement circuit 29.

The control module CM includes a power supply circuit 113 and a drive signal generation circuit 114. The power supply circuit 113 receives supply of electric power from a commercial power source (not shown) and generates various predetermined potentials. The various generated potentials are supplied to each portion of the ink jet printer 100 as appropriate. In the example shown in FIG. 3, the power supply circuit 113 generates a power supply potential VHV and an offset potential VBS. The offset potential VBS is supplied to the liquid ejecting head 30. Additionally, the power supply potential VHV is supplied to the drive signal generation circuit 114 and the like.

The drive signal generation circuit 114 is a circuit that generates a drive signal Com for driving the liquid ejecting head 30. Specifically, the drive signal generation circuit 114 includes, for example, a DA conversion circuit and an amplification circuit. In the drive signal generation circuit 114, the DA conversion circuit converts a waveform designation signal dCom, which will be described below, from the control circuit 21 from a digital signal into an analog signal, and the amplification circuit generates the drive signal Com by amplifying the analog signal using the power supply potential VHV from the power supply circuit 113.

The liquid supply system 10 includes a liquid container 12 and a sub tank 13. The liquid container 12 stores ink. The sub tank 13 temporarily stores ink supplied from the liquid container 12.

The liquid container 12 includes, for example, a cartridge that is attachable to and detachable from the ink jet printer 100, a bag-shaped ink pack formed of a flexible film, or an ink tank capable of being refilled with ink. The liquid container 12 includes liquid containers 12a and 12b. For example, different color inks are stored in the liquid containers 12a and 12b. A first ink is stored in the liquid container 12a. For example, a second ink having a color different from that of the first ink is stored in the liquid container 12b.

The sub tank 13 includes sub tanks 13a and 13b. The sub tank 13a is coupled to the liquid container 12a and temporarily stores the first ink. The sub tank 13b is coupled to the liquid container 12b and temporarily stores the second ink. In addition, a supply tube Ta_in and a discharge tube Ta_out are coupled to the sub tank 13a. A supply tube Tb_in and a discharge tube Tb_out are coupled to the sub tank 13b. These tubes are coupled to the head module 3. Such a sub tank 13 supplies ink to the head module 3 and collects ink from the head module 3. Accordingly, ink circulates between the sub tank 13 and the head module 3.

The ink is, for example, an aqueous pigment ink, a solvent ink, or an ultraviolet curable ink. The solvent ink is an ink containing an organic solvent. The solvent ink is an ink in which, after being applied to the medium PP, the organic solvent penetrates into the medium PP to form a receiving layer, and a color material is fixed on the receiving layer. The ultraviolet curable ink is an ink containing an ultraviolet curable component. Hereinafter, the ultraviolet curable ink will be referred to as an ultraviolet (UV) ink. The ultraviolet curable component contains a monomer or an oligomer. The UV ink is ink in which, after being applied to the medium PP, the ultraviolet curable component is cured by irradiation with ultraviolet rays, and a color material is fixed in a coating formed by curing of the ultraviolet curable component.

The storage circuit 22 stores various programs including a control program PM2 executed by the control circuit 21 and various kinds of data such as the image data Img processed by the control circuit 21. The storage circuit 22 includes, for example, semiconductor memories of one or both of one or more volatile memories, such as a RAM, and one or more non-volatile memories, such as a ROM, an EEPROM, or a PROM. The storage circuit 22 may be configured as a part of the control circuit 21.

The transport mechanism 23 transports the medium PP along the Y-axis under the control of the control circuit 21. The moving mechanism 24 reciprocates the head module 3 along the X-axis under the control of the control circuit 21.

The moving mechanism 24 includes a substantially box-shaped support 241 that accommodates the head module 3, and an endless belt 242 to which the support 241 is fixed.

The communication device 28 is a circuit that can communicate with the processing apparatus 200. For example, the communication device 28 is a network card, such as USB or Bluetooth. In addition, the communication device 28 may be integrated with the control circuit 21.

The head module 3 ejects ink supplied from the sub tank 13 onto the medium PP under the control of the control circuit 21. By ejecting ink from the head module 3 onto the medium PP in parallel with transport of the medium PP by the transport mechanism 23 and repetitive reciprocation of the support 241, an image is formed on a surface of the medium PP. Ink not ejected from the head module 3 is discharged to the sub tank 13. The head module 3 includes one liquid ejecting head 30, but may include a plurality of liquid ejecting heads 30.

The description returns to FIGS. 3 and 4. The control circuit 21 controls each element provided in the ink jet printer 100. The control circuit 21 includes, for example, one or more of processing circuits, such as a CPU or an FPGA, and one or more of storage circuits, such as a semiconductor memory.

The control circuit 21 controls the operation of each portion of the ink jet printer 100 by executing a program stored in the storage circuit 22. Here, the control circuit 21 generates signals such as a control signal Sk1, a control signal Sk2, a print signal SI, a waveform designation signal dCom, and a request signal RI as signals for controlling the operation of each portion of the ink jet printer 100.

The control signal Sk1 is a signal for controlling driving of the moving mechanism 24. The control signal Sk2 is a signal for controlling driving of the transport mechanism 23. The print signal SI is a signal for controlling driving of the liquid ejecting head 30. The waveform designation signal dCom is a digital signal for defining a waveform of the drive signal Com generated by the drive signal generation circuit 114.

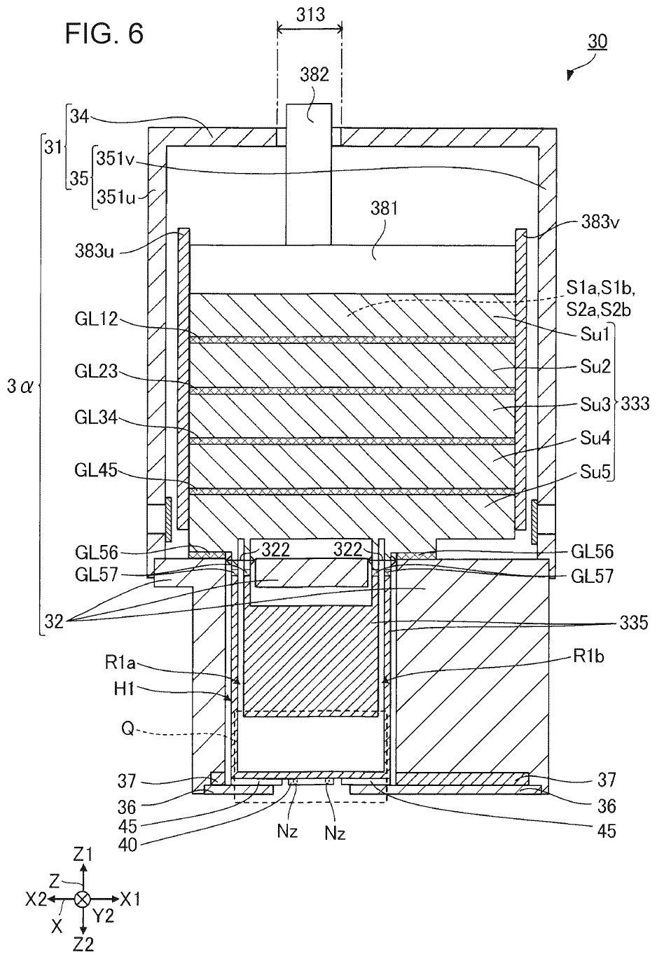

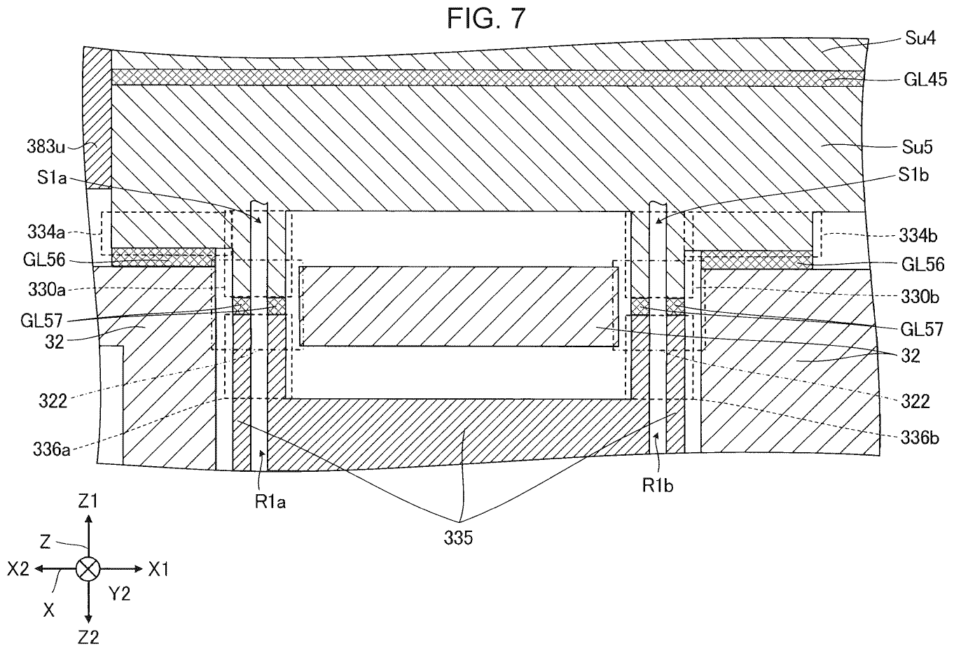

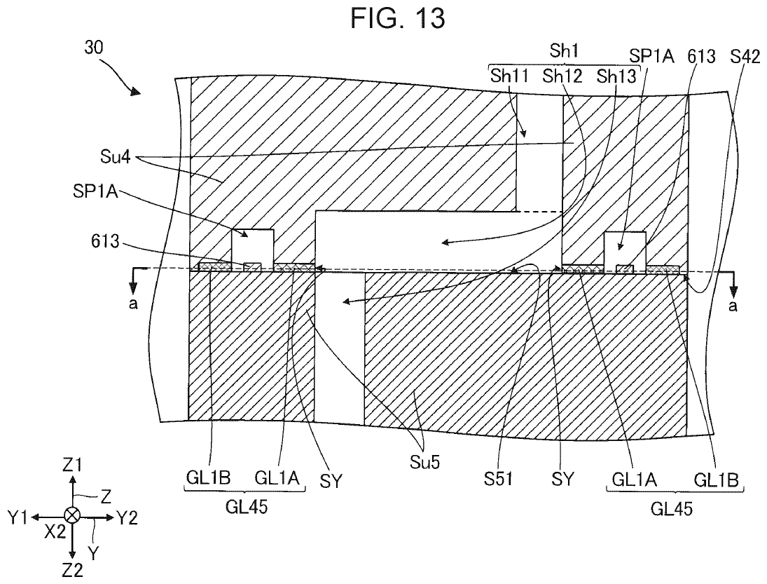

The measurement circuit 29 executes a measurement process of measuring a current value in a detection mechanism 60A provided in the liquid ejecting head 30 by using the detection mechanism 60A. The request signal RI is a signal for requesting the measurement circuit 29 to execute the measurement process. The measurement circuit 29 transmits measurement information JI indicating a measurement result to the control circuit 21. The detection mechanism 60A will be described below with reference to FIGS. 13, 14, and 15, and illustration and description thereof are omitted in FIGS. 6 and 7.

### 1-5. Overall Configuration of Liquid Ejecting Head 30

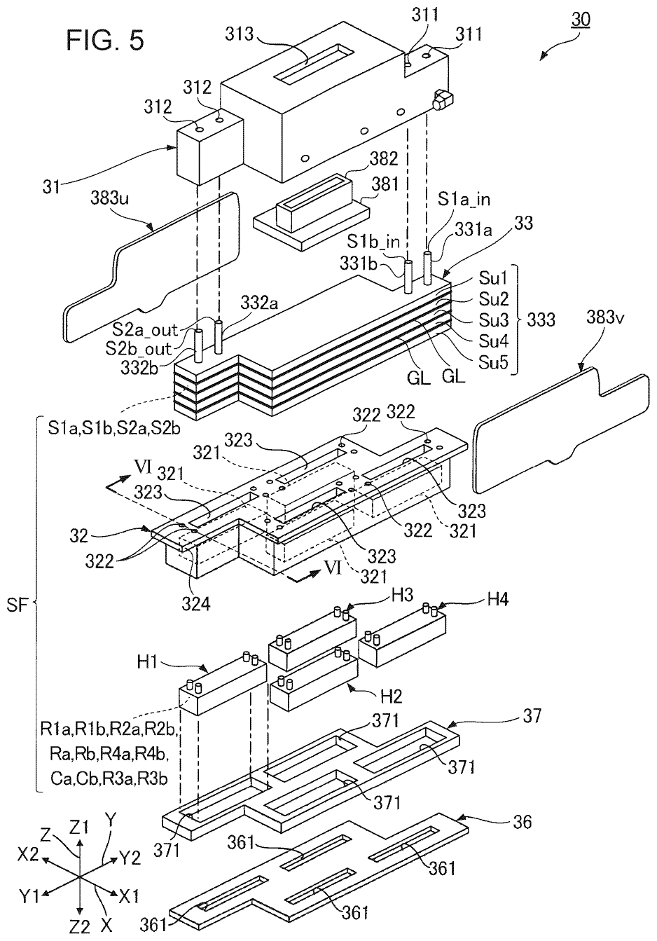

FIG. 5 is an exploded perspective view of the liquid ejecting head 30. FIG. 6 is a cross-sectional view of the liquid ejecting head 30 taken along line VI-VI in FIG. 5. The view shown in FIG. 6 is a view of a cross-section of the liquid ejecting head 30 taken along line VI-VI as viewed in the Y2 direction. The line VI-VI is an imaginary line segment passing through two ink holes 322 and along the X-axis direction.

As shown in FIG. 5, the liquid ejecting head 30 includes a housing 3α, a flow path structure 33, a fixing plate 36, and a reinforcing plate 37. Additionally, the liquid ejecting head 30 includes a plurality of head units H1, H2, H3, and H4. The head units H1, H2, H3, and H4 are referred to as a head unit Hn unless otherwise distinguished. In addition, the liquid ejecting head 30 includes electrical elements such as a wiring substrate 381, a wiring member 382, and circuit boards 383u and 383v. Further, the flow path structure 33 includes a laminate 333, supply coupling portions 331a and 331b, and discharge coupling portions 332a and 332b. Hereinafter, each element provided in the liquid ejecting head 30 will be described with reference to FIGS. 5 and 6.

The housing 3α shown in FIGS. 5 and 6 is a hollow case that accommodates the head unit Hn and the laminate 333. The housing 3α includes a cover member 31 and a holder member 32.

The cover member 31 accommodates the laminate 333. The holder member 32 accommodates the plurality of head units Hn. In the present embodiment, the holder member 32 accommodates four head units Hn. The holder member 32 is disposed in the Z2 direction with respect to the cover member 31.

As shown in FIG. 5, the cover member 31 includes two first coupling portion holes 311, two second coupling portion holes 312, and a first hole 313. The first hole 313 is a hole through which the wiring member 382 is inserted. One of the supply coupling portions 331a and 331b is inserted through and fitted into each first coupling portion hole 311. One of the discharge coupling portions 332a and 332b is inserted through and fitted into each second coupling portion hole 312.

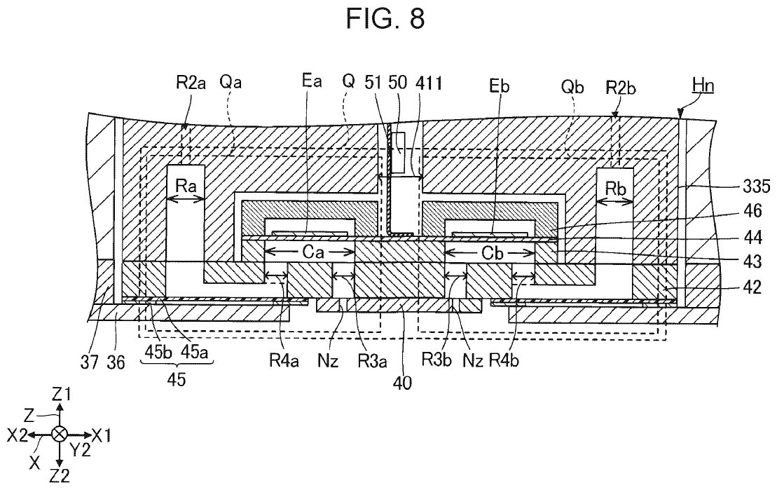

The holder member 32 includes a plurality of recessed portions 321, a plurality of ink holes 322, and a plurality of wiring holes 323. Each recessed portion 321 is a depression that is open in the Z2 direction. The head unit Hn is disposed in each recessed portion 321. Each ink hole 322 is a hole through which ink flows between the flow path structure 33 and the head unit Hn. Each wiring hole 323 communicates with the recessed portion 321. Each wiring hole 323 is a hole through which a flexible substrate 51 shown in FIG. 8 is passed. The flexible substrate 51 is provided for each head unit Hn and is electrically coupled to the head unit Hn. In addition, as shown in FIG. 5, the holder member 32 includes a flange 324 for fixing the holder member 32 to the support 241.

As shown in FIG. 6, the housing 3α includes an upper wall portion 34 and a side wall portion 35. The side wall portion 35 includes side walls 351u and 351v.

As shown in FIG. 5, the laminate 333 of the flow path structure 33 includes a plurality of flow path plates Su1, Su2, Su3, Su4, and Su5, and the plurality of flow path plates Su1, Su2, Su3, Su4, and Su5 are referred to as a flow path plate Su unless otherwise distinguished. Each flow path plate Su is formed by, for example, injection molding of a resin, but may also be formed of a metal.

The flow path plates Su1 to Su5 are bonded to each other by an adhesive that forms bonding portions GL12, GL23, GL34, and GL45. The flow path plate Su5 is bonded in the Z1 direction to the holder member 32 by an adhesive that forms a bonding portion GL56. In the following description, a layer formed by an adhesive in the liquid ejecting head 30 is collectively referred to as a bonding portion GL. The bonding portion GL liquid-tightly couples two members. An adhesive forming the bonding portion GL is, for example, an epoxy-based adhesive containing an epoxy resin as a main component, but may also be a silicone-based adhesive or the like.

The liquid ejecting head 30 includes a flow path SF communicating with the nozzle Nz inside. The flow path SF includes in-structure supply flow paths S1a and S1b, in-structure discharge flow paths S2a and S2b, in-head supply flow paths R1a and R1b, in-head discharge flow paths R2a and R2b, a first liquid storage chamber Ra, a second liquid storage chamber Rb, second communication flow paths R4a and R4b, pressure chambers Ca and Cb, and first communication flow paths R3a and R3b. The flow path SF is an example of a “flow path communicating with the nozzle”.

The laminate 333 includes the in-structure supply flow paths S1a and S1b and the in-structure discharge flow paths S2a and S2b. The in-structure supply flow paths S1a and S1b and the in-structure discharge flow paths S2a and S2b are referred to as an in-structure flow path Sn unless otherwise distinguished. Each in-structure flow path Sn is a space formed in the laminate 333. The ink flows through the in-structure flow path Sn. Each in-structure flow path Sn is formed by one or both of grooves along an X-Y plane provided in each of two flow path plates Su adjacent to each other, and a hole in the flow path plate Su that extends in the Z-axis direction. In FIG. 6, the in-structure flow path Sn is not shown in order to prevent the drawing from being complicated.

Specifically, the in-structure supply flow path S1a supplies the first ink stored in the sub tank 13a to the plurality of head units Hn. The in-structure supply flow path S1b supplies the second ink stored in the sub tank 13b to the plurality of head units Hn. The in-structure discharge flow path S2a discharges the first ink that is not ejected from the plurality of head units Hn to the sub tank 13a. The in-structure discharge flow path S2b discharges the second ink that is not ejected from the plurality of head units Hn to the sub tank 13b. A filter portion Fa including a filter that captures foreign matter or bubbles mixed into ink may be installed in each in-structure flow path Sn.

Each of the supply coupling portions 331a and 331b and the discharge coupling portions 332a and 332b is provided in the Z1 direction with respect to the laminate 333 and protrudes from the laminate 333 in the Z1 direction. Each of the supply coupling portions 331a and 331b and the discharge coupling portions 332a and 332b is a coupling tube for communication between each in-structure flow path Sn and the outside of the housing 3α.

Specifically, the supply coupling portion 331a is a supply tube through which the first ink is supplied from the sub tank 13a to the in-structure supply flow path S1a, and is provided with a supply port S1a_in for supplying the first ink to the laminate 333. The supply coupling portion 331b is a supply tube through which the second ink is supplied from the sub tank 13b to the in-structure supply flow path S1b, and is provided with a supply port S1b_in for supplying the second ink to the laminate 333. The discharge coupling portion 332a is a discharge tube through which the first ink is discharged from the in-structure discharge flow path S2a to the sub tank 13a, and is provided with a discharge port S2a_out for discharging the first ink from the laminate 333. The discharge coupling portion 332b is a discharge tube through which the second ink is discharged from the in-structure discharge flow path S2b to the sub tank 13b, and is provided with a discharge port S2b_out for discharging the second ink from the laminate 333.

The head unit Hn includes the in-head supply flow paths R1a and R1b, the in-head discharge flow paths R2a and R2b, and a liquid ejecting portion Q that ejects ink. The first liquid storage chamber Ra, the second liquid storage chamber Rb, the second communication flow paths R4a and R4b, the pressure chambers Ca and Cb, and the first communication flow paths R3a and R3b are provided in the liquid ejecting portion Q. The flow paths provided in the liquid ejecting portion Q are shown in FIG. 8.

In FIG. 6, the detailed shape of the liquid ejecting portion Q is not shown in order to prevent the drawing from being complicated. The detailed shape of the liquid ejecting portion Q will be described below with reference to FIG. 8. As shown in FIG. 6, each head unit Hn includes a plurality of nozzles Nz. Each nozzle Nz is a through-hole for ejecting ink in the Z2 direction. Specifically, each head unit Hn includes a plurality of nozzles Nz that eject the first ink and a plurality of nozzles Nz that eject the second ink. Additionally, each head unit Hn defines the in-head supply flow paths R1a and R1b and the in-head discharge flow paths R2a and R2b.

The in-head supply flow paths R1a and R1b are flow paths from an end portion of the head unit Hn in the Z1 direction to the liquid ejecting portion Q. The in-head discharge flow paths R2a and R2b are flow paths from the liquid ejecting portion Q to the end portion of the head unit Hn in the Z1 direction. The in-head supply flow paths R1a and R1b and the in-head discharge flow paths R2a and R2b are referred to as an in-head flow path Rn unless otherwise distinguished.

The head unit Hn includes a case 335 that defines the in-head flow path Rn.

FIG. 7 is an enlarged view of a vicinity of the ink hole 322 shown in FIG. 6. The flow path plate Su5 includes columnar projecting portions 334a and 334b protruding in the Z2 direction. The projecting portions 334a and 334b are bonded in the Z1 direction to the holder member 32 by an adhesive forming the bonding portion GL56.

The flow path plate Su5 includes flow path plate side communication tubes 330a and 330b. The flow path plate side communication tubes 330a and 330b are collectively referred to as a flow path plate side communication tube 330. The flow path plate side communication tube 330 protrudes from the flow path plate Su5 toward the case 335 and is inserted through the ink hole 322.

The case 335 includes case side communication tubes 336a and 336b. The case side communication tubes 336a and 336b are collectively referred to as a case side communication tube 336. The case side communication tube 336 protrudes from the case 335 toward the flow path plate Su5 and is inserted through the ink hole 322.

An adhesive forming a bonding portion GL57 is applied to a top surface of the flow path plate side communication tube 330 and a top surface of the case side communication tube 336.

A flow direction of ink in the in-head supply flow paths R1a and R1b is the Z2 direction. The top surface of the flow path plate side communication tube 330 and the top surface of the case side communication tube 336 are perpendicular to the flow direction of ink.

The description returns to FIGS. 5 and 6. As shown in FIG. 5, the fixing plate 36 is a plate member for fixing the plurality of head units Hn to the holder member 32. The fixing plate 36 includes a plurality of opening portions 361 for exposing the nozzles Nz of the plurality of head units Hn.

The reinforcing plate 37 is disposed between the holder member 32 and the fixing plate 36 and is fixed to the fixing plate 36 by an adhesive. The reinforcing plate 37 includes a plurality of opening portions 371 in which the plurality of head units Hn are disposed.

The wiring substrate 381 is a mounting component for electrically coupling the liquid ejecting head 30 to the control circuit 21 shown in FIG. 4. The wiring substrate 381 is disposed on the laminate 333. The wiring member 382 is installed on the wiring substrate 381. The wiring member 382 is a member for electrically coupling the liquid ejecting head 30 and the control circuit 21. The wiring member 382 is, for example, a connector. The wiring member 382 may be, for example, a signal cable such as a flexible flat cable (FFC).

The circuit boards 383u and 383v are disposed to sandwich the laminate 333 and are electrically coupled to the wiring substrate 381. The flexible substrate 51 mounted on each of the head units H1 and H3 is electrically coupled to the circuit board 383u via a relay substrate (not shown). The flexible substrate 51 mounted on each of the head units H2 and H4 is electrically coupled to the circuit board 383v via a relay substrate (not shown).

### 1-6. Head Unit Hn

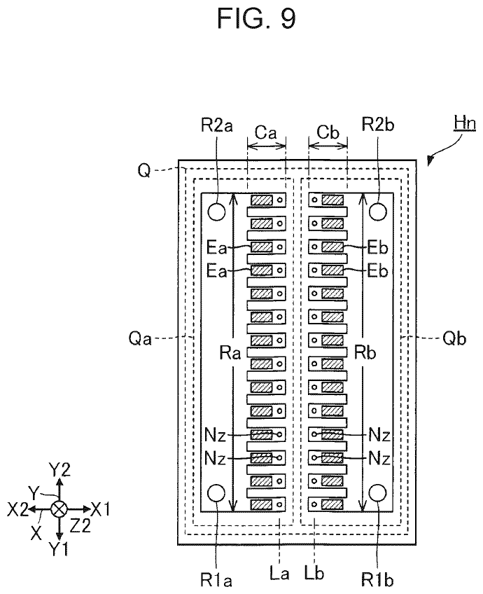

FIG. 8 is a cross-sectional view of the head unit Hn taken along the X-axis direction through the wiring hole 323. The view shown in FIG. 8 is a view of a cross-section of the head unit Hn taken along the X-axis direction through the wiring hole 323 as viewed in the Y2 direction. FIG. 9 is a plan view schematically showing the inside of the head unit Hn. The view shown in FIG. 9 is a plan view of the inside of the head unit Hn as viewed in the Z2 direction. In each of FIGS. 8 and 9, a portion of the head unit Hn shown in FIG. 6 in the vicinity of the fixing plate 36 is shown.

As shown in FIG. 8, the head unit Hn includes the nozzle plate 40, a communication plate 42, a pressure chamber substrate 43, a diaphragm 44, a plurality of drive elements E, a protection portion 46, a compliance substrate 45, and the case 335 mentioned above.

Each of the nozzle plate 40, the communication plate 42, the pressure chamber substrate 43, and the diaphragm 44 is an elongated plate-shaped member along the Y-axis. The pressure chamber substrate 43 and the case 335 are disposed in the Z1 direction with respect to the communication plate 42. On the other hand, the nozzle plate 40 and the compliance substrate 45 are disposed in the Z2 direction with respect to the communication plate 42. In addition, the members provided in the head unit Hn are joined to each other by an adhesive. Although not shown in FIG. 8, the layer formed by the adhesive joining the members provided in the head unit Hn to each other is also included in the bonding portion GL.

As shown in FIG. 9, the plurality of nozzles Nz are classified into a first nozzle row La and a second nozzle row Lb. Each of the first nozzle row La and the second nozzle row Lb is a group of a plurality of nozzles Nz arranged linearly along the Y-axis. The first nozzle row La and the second nozzle row Lb are spaced apart from each other and are arranged in the X-axis direction. Here, the liquid ejecting portion Q includes a first liquid ejecting portion Qa including a plurality of nozzles Nz belonging to the first nozzle row La, and a second liquid ejecting portion Qb including a plurality of nozzles Nz belonging to the second nozzle row Lb. The first liquid ejecting portion Qa ejects the first ink supplied from the sub tank 13a, from each nozzle Nz of the first nozzle row La. The second liquid ejecting portion Qb ejects the second ink supplied from the sub tank 13b, from each nozzle Nz of the second nozzle row Lb.

In the following description, a subscript “a” is added to reference numerals of elements related to the first nozzle row La, and a subscript “b” is added to reference numerals of elements related to the second nozzle row Lb. Additionally, elements related to the first liquid ejecting portion Qa and elements related to the second liquid ejecting portion Qb are disposed in a substantially plane-symmetrical structure. Accordingly, in the following description, elements corresponding to the first liquid ejecting portion Qa will be mainly described, and descriptions of elements corresponding to the second liquid ejecting portion Qb will be omitted as appropriate.

As shown in FIG. 8, the communication plate 42 is provided with the first communication flow path R3a and the second communication flow path R4a. Each of the first communication flow path R3a and the second communication flow path R4a is provided for each nozzle Nz. The nozzle Nz communicates with the pressure chamber Ca, which will be described below, through the first communication flow path R3a. The nozzle Nz communicates with the first liquid storage chamber Ra, which will be described below, through the second communication flow path R4a. Additionally, the compliance substrate 45 constitutes a part of a wall surface of the first liquid storage chamber Ra. The compliance substrate 45 includes, for example, a resin film 45a having flexibility and a metal plate 45b such as stainless steel.

The pressure chamber substrate 43 is provided with a plurality of pressure chambers Ca. The pressure chamber Ca is a space that communicates with the nozzle Nz via the first communication flow path R3a. The diaphragm 44 that is elastically deformable is disposed above the pressure chamber Ca. A part or all of the diaphragm 44 may be a separate member from the pressure chamber substrate 43 or may be integrated. In addition, a drive element Ea is formed for each pressure chamber Ca on a surface of the diaphragm 44 on a side opposite to the pressure chamber Ca. A plurality of drive elements Ea are disposed in one-to-one correspondence with the plurality of nozzles Nz. The drive element Ea generates energy for ejecting ink. Specifically, the drive element Ea ejects ink from the nozzle Nz by the application of the drive signal. For example, the drive element Ea is a piezoelectric element that changes the volume of the pressure chamber Ca.

The protection portion 46 is disposed above the diaphragm 44. In addition, the flexible substrate 51 is joined to a surface of the diaphragm 44. A plurality of wirings for electrically coupling the control circuit 21 and the head unit Hn are formed at the flexible substrate 51. Further, a drive circuit 50 that drives the drive element E is mounted on the flexible substrate 51. The drive circuit 50 selects whether or not to supply various signals, such as a drive signal for driving each drive element Ea, to each drive element Ea based on signals output from the control circuit 21.

The case 335 includes the first liquid storage chamber Ra for storing ink. Additionally, the case 335 includes a part of the in-head supply flow paths R1a and R1b and the in-head discharge flow paths R2a and R2b mentioned above. As shown in FIG. 8, each of the in-head supply flow path R1a and the in-head discharge flow path R2a is coupled to the first liquid storage chamber Ra. Further, as shown in FIG. 8, the case 335 includes a substrate hole 411 through which the flexible substrate 51 is inserted.

### 1-7. Shape of In-structure Flow Path Sn

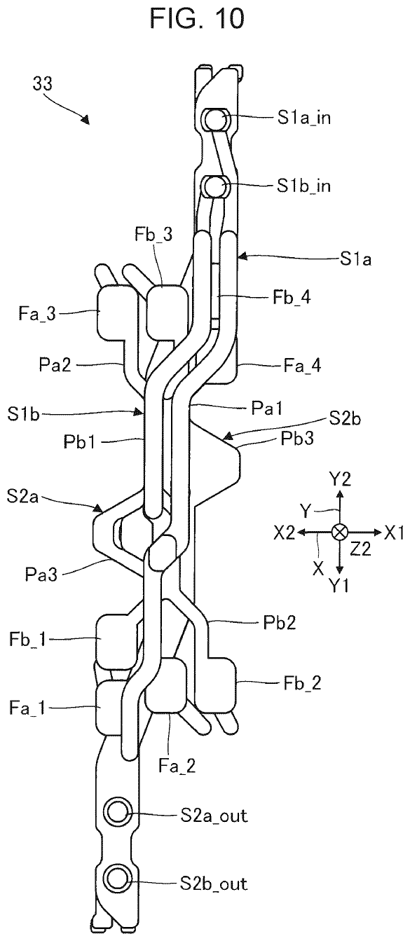

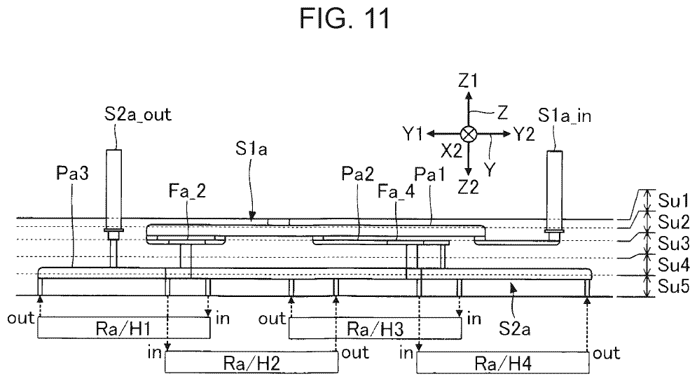

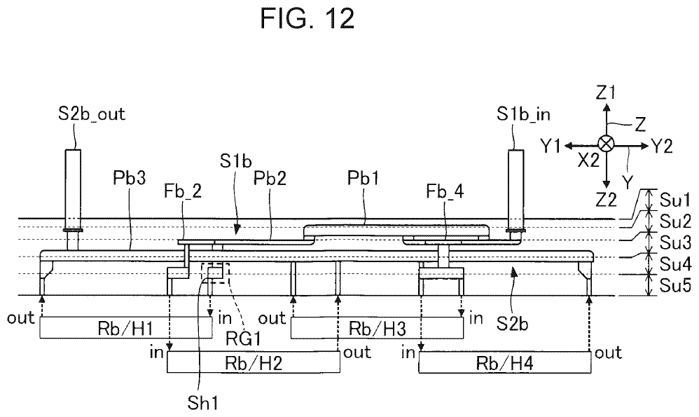

FIG. 10 is a plan view exemplifying the in-structure flow path Sn. FIG. 11 is a side view of the in-structure supply flow path S1a and the in-structure discharge flow path S2a of the in-structure flow path Sn, through which the first ink flows. FIG. 12 is a side view of the in-structure supply flow path S1b and the in-structure discharge flow path S2b of the in-structure flow path Sn, through which the second ink flows. In FIGS. 11 and 12, the first liquid storage chamber Ra of each head unit Hn is indicated by reference numeral “Ra/Hn”, and the second liquid storage chamber Rb of each head unit Hn is indicated by reference numeral “Rb/Hn”. The configuration of the in-structure flow path Sn is not limited to the following configuration.

As exemplified in FIGS. 10, 11, and 12, the flow path structure 33 is provided with the in-structure supply flow paths S1a and S1b and the in-structure discharge flow paths S2a and S2b. The in-structure supply flow path S1a is a flow path from the supply port S1a_in to the in-head supply flow path R1a of each head unit Hn, and the in-structure discharge flow path S2a is a flow path from the in-head discharge flow path R2a of each head unit Hn to the discharge port S2a_out. The in-structure supply flow path S1b is a flow path from the supply port S1b_in to the in-head supply flow path R1b of each head unit Hn, and the in-structure discharge flow path S2b is a flow path from the in-head discharge flow path R2b of each head unit Hn to the discharge port S2b_out.

As exemplified in FIGS. 10 and 11, the in-structure supply flow path S1a is a flow path including a supply portion Pa1, a coupling portion Pa2, and four filter portions Fa_1 to Fa_4. As exemplified in FIG. 11, the supply portion Pa1 is formed between the flow path plates Su1 and Su2. The supply portion Pa1 has a shape extending along the Y-axis. An end portion of the supply portion Pa1 in the Y2 direction communicates with the supply port S1a_in.

As exemplified in FIGS. 10 and 12, the in-structure supply flow path S1b is a flow path including a supply portion Pb1, a coupling portion Pb2, and four filter portions Fb_1 to Fb_4. As exemplified in FIG. 12, the supply portion Pb1 is formed between the flow path plates Su1 and Su2. The supply portion Pb1 has a shape extending along the Y-axis. An end portion of the supply portion Pb1 in the Y2 direction communicates with the supply port S1b_in.

The coupling portion Pa2 and the four filter portions Fa_1 to Fa_4 are formed between the flow path plates Su2 and Su3. The coupling portion Pa2 communicates with the supply portion Pa1 via a through-hole formed in the flow path plate Su2. The coupling portion Pa2 extends in the Y2 direction from a coupling position to the supply portion Pa1 and branches into two systems to communicate with the filter portions Fa_1 and Fa_3.

The filter portion Fa_2 communicates with the supply portion Pa1 via a through-hole formed in the flow path plate Su2. The filter portion Fa_4 communicates with the supply portion Pa1 via a through-hole formed in the flow path plate Su2. Each of the filter portions Fa_1 to Fa_4 communicates with the in-head supply flow path R1a of each head unit Hn via a through-hole penetrating through the flow path plates Su3 to Su5.

As exemplified in FIGS. 10 and 12, the in-structure supply flow path S1b is a flow path including a supply portion Pb1, a coupling portion Pb2, and four filter portions Fb_1 to Fb_4. The supply portion Pb1 is formed between the flow path plates Su1 and Su2. The supply portion Pb1 has a shape extending along the Y-axis. The supply port S1b_in communicates with an end of the supply portion Pb1 in the Y2 direction. Here, the supply portions Pa1 and Pb1 are provided in parallel between the flow path plates Su1 and Su2.

The coupling portion Pb2 and the four filter portions Fb_1 to Fb_4 are formed between the flow path plates Su2 and Su3. The coupling portion Pb2 communicates with the supply portion Pb1 via a through-hole formed in the flow path plate Su2. The coupling portion Pb2 extends in the Y1 direction from a coupling position to the supply portion Pb1 and branches into two systems to communicate with the filter portions Fb_2 and Fb_4. Here, the coupling portion Pb2 extends in a direction opposite to the coupling portion Pa2 from the coupling position to the supply portion Pb1.

The filter portion Fb_1 communicates with the supply portion Pb1 via a through-hole formed in the flow path plate Su2. The filter portion Fb_3 communicates with the supply portion Pb1 via a through-hole formed in the flow path plate Su2. Each of the filter portions Fb_1 to Fb_4 communicates with the in-head supply flow path R1b of each head unit Hn via a through-hole penetrating through the flow path plates Su3 to Su5.

As exemplified in FIGS. 10 and 11, the in-structure discharge flow path S2a is a flow path including a discharge portion Pa3. The discharge portion Pa3 is formed between the flow path plates Su4 and Su5. The discharge portion Pa3 has a shape that extends along the Y-axis over a wider range than the supply portion Pa1. A vicinity of an end portion of the discharge portion Pa3 in the Y1 direction communicates with the discharge port S2a_out. The in-head discharge flow path R2a of each head unit Hn communicates with the discharge portion Pa3 via a through-hole penetrating through the flow path plate Su5.

As exemplified in FIGS. 10 and 12, the in-structure discharge flow path S2b is a flow path including a discharge portion Pb3. The discharge portion Pb3 is formed between the flow path plates Su3 and Su4. The discharge portion Pb3 has a shape that extends along the Y-axis over a wider range than the supply portion Pb1. A vicinity of an end portion of the discharge portion Pb3 in the Y1 direction communicates with the discharge port S2b_out. The in-head discharge flow path R2b of each head unit Hn communicates with the discharge portion Pb3 via a through-hole penetrating through the flow path plates Su4 and Su5.

### 1-8. Detection Mechanism 60A and Measurement Circuit 29

In order to detect a sign of ink leakage from the liquid ejecting head 30, the detection mechanism 60A is provided in the vicinity of the bonding portion GL that bonds the two flow path members. A set of two flow path members is two members constituting the liquid ejecting head 30 and need only be two members constituting a part of the flow path SF and bonded using some kind of adhesive. Specifically, the set of two flow path members is a set of two adjacent flow path plates Su in the flow path structure 33 and a set of the flow path plate Su5 and the case 335, and is a set of two members constituting the head unit Hn, constituting a part of the flow path SF, and bonded using some kind of adhesive. The set of two members in the head unit Hn is specifically a set of the case 335 and the communication plate 42, a set of the communication plate 42 and the pressure chamber substrate 43, a set of the communication plate 42 and the compliance substrate 45, a set of the communication plate 42 and the nozzle plate 40, and a set of the pressure chamber substrate 43 and the diaphragm 44. The detection mechanism 60A will be described with reference to FIGS. 13, 14, and 15.

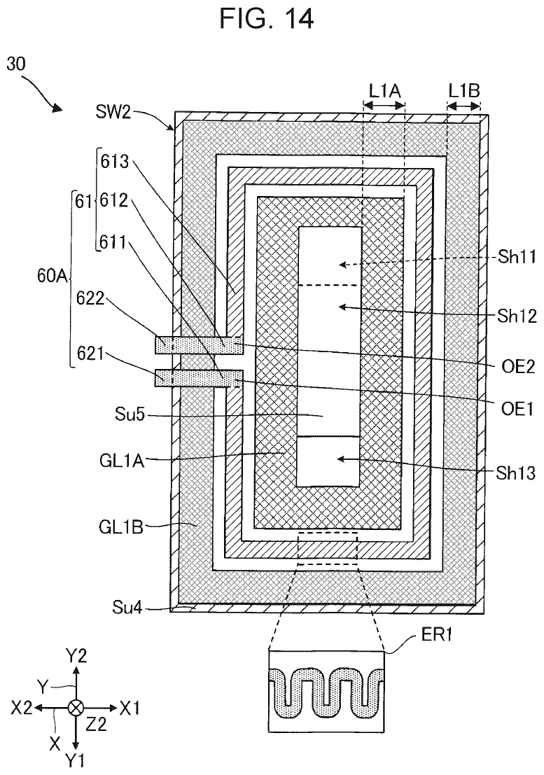

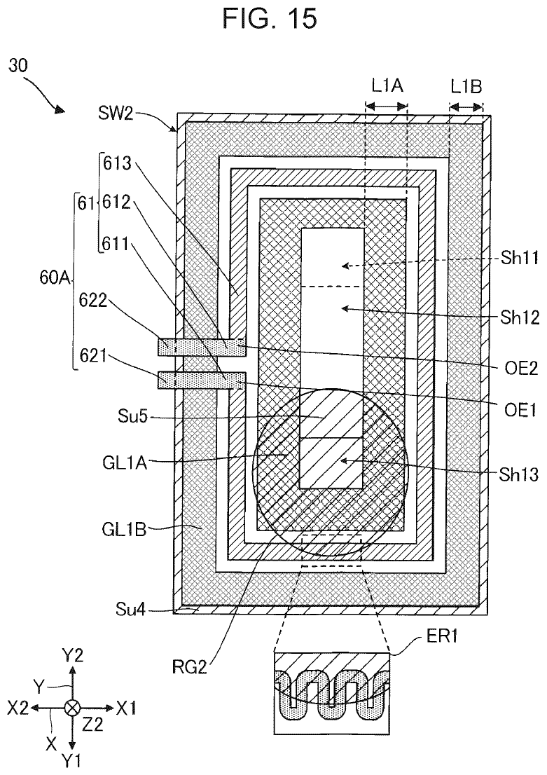

FIGS. 13, 14, and 15 are views illustrating the detection mechanism 60A. A location where the detection mechanism 60A is provided may be any of the sets of two flow path members mentioned above, and may also be provided in a plurality of sets. FIGS. 13, 14, and 15 show an example in which the detection mechanism 60A is provided in a region RG1 shown in FIG. 12. The region RG1 includes a supply flow path Sh1 that is a part of the in-structure supply flow path S1b and formed by the flow path plates Su4 and Su5. Additionally, in the subsequent drawings, in order to prevent the drawings from being complicated, shapes of the flow path structure 33 and the flow paths inside the flow path structure 33 are shown in a simplified manner as appropriate. In FIG. 13, the region RG1 is shown in an enlarged manner. FIGS. 14 and 15 show cross-sections of the liquid ejecting head 30 taken along line a-a shown in FIG. 13.

As shown in FIG. 13, the supply flow path Sh1 includes a vertical flow path Sh11 extending in the direction along the Z-axis, a horizontal flow path Sh12 extending in the direction perpendicular to the Z-axis, and a vertical flow path Sh13 extending in the direction along the Z-axis. In FIGS. 14 and 15, the position of the vertical flow path Sh11 is shown in order to show a positional relationship. An end portion of the vertical flow path Sh11 in the Z2 direction communicates with an end portion of the horizontal flow path Sh12 in the Y2 direction. An end portion of the horizontal flow path Sh12 in the Y1 direction communicates with an end portion of the vertical flow path Sh13 in the Z1 direction. In the first embodiment, the detection mechanism 60A is provided at a location where the horizontal flow path Sh12 is provided, but the detection mechanism 60A may be provided at a location where the horizontal flow path Sh12 is not provided. The supply flow path Sh1 communicates with the nozzle Nz of the head unit H1 among the plurality of nozzles Nz provided in the liquid ejecting head 30. The supply flow path Sh1 is an example of a “first flow path”, and the nozzle Nz of the head unit H1 is an example of “one or more nozzles among the plurality of nozzles”.

FIG. 13 shows a vicinity of the region RG1. FIGS. 14 and 15 show a location where the detection mechanism 60A is provided.

As shown in FIG. 14, the detection mechanism 60A includes a detection conductive wire 61 and detection wirings 621 and 622. In the first embodiment, it is possible to detect a sign of ink leakage from the liquid ejecting head 30 based on the magnitude of the current of the detection conductive wire 61. In the first embodiment, it is assumed that the ink has conductive properties. The ink having conductive properties is, for example, an aqueous ink containing an electrolyte. However, the ink having conductive properties is not limited to the aqueous ink having an electrolyte and may be UV ink having an electrolyte.

As shown in FIG. 13, the bonding portion GL45 includes first bonding portions GL1A and GL1B. The first bonding portions GL1A and GL1B join a surface S51 of the flow path plate Su5 that faces the Z1 direction and a surface S42 of the flow path plate Su4 that faces the Z2 direction. The first bonding portion GL1A defines an inner wall SY of the supply flow path Sh1 and is provided to surround the supply flow path Sh1. The first bonding portion GL1B is provided to surround the first bonding portion GL1A with a spacing from the first bonding portion GL1A. As shown in FIGS. 14 and 15, in plan view, each of the first bonding portions GL1A and GL1B has an annular shape. Adhesives forming the first bonding portions GL1A and GL1B may be of the same type or may be of different types from each other. In the first embodiment, it is assumed that the adhesives forming the first bonding portions GL1A and GL1B are of the same type.

FIG. 14 shows an initial state of the liquid ejecting head 30. In the present specification, the initial state of the liquid ejecting head 30 means a state after the liquid ejecting head 30 is manufactured and before the liquid ejecting head 30 is filled with ink. In addition, the initial state of the liquid ejecting head 30 can also be referred to as a state in which the bonding portion GL is not in contact with ink. In FIG. 15, a range RG2 in which ink is present because of deterioration of a part of the first bonding portion GL1A is shown.

As understood from FIGS. 13, 14, and 15, in a state immediately after the liquid ejecting head 30 is filled with ink from the initial state of the liquid ejecting head 30, only the first bonding portion GL1A among the first bonding portions GL1A and GL1B is in contact with the ink. When the first bonding portion GL1A deteriorates and ink leaks from the first bonding portion GL1A, the first bonding portions GL1A and GL1B are in contact with the ink.

FIG. 15 shows a state in which ink leaks from the first bonding portion GL1A because of deterioration of the first bonding portion GL1A.

The detection conductive wire 61 is disposed on the surface S51. The detection conductive wire 61 includes conductive wire portions 611, 612, and 613. The conductive wire portions 611 and 612 extend in the direction along the X-axis. However, extending directions of the conductive wire portions 611 and 612 are not limited to the direction along the X-axis and need only be a direction toward a side surface of the flow path structure 33. An end portion of the conductive wire portion 611 in the X1 direction is coupled to one end OE1 of the conductive wire portion 613. An end portion of the conductive wire portion 612 in the X1 direction is coupled to one end OE2 of the conductive wire portion 613. An end portion of the conductive wire portion 611 in the X2 direction is coupled to one end of the detection wiring 621. An end portion of the conductive wire portion 612 in the X2 direction is coupled to one end of the detection wiring 622. The detection wirings 621 and 622 function as lead-out wires of the detection conductive wire 61. The detection wirings 621 and 622 are coupled to the measurement circuit 29 via a wiring member (not shown).

As understood from FIG. 13, the conductive wire portion 613 is accommodated in a first space SP1A formed by cutting out the surface S42 of the flow path plate Su4 in the Z1 direction. In plan view, the first space SP1A coincides with the spacing between the first bonding portions GL1A and GL1B. In plan view, the first space SP1A has an annular shape. However, the shape of the first space SP1A need not be annular, and in plan view, the first space SP1A need not be present at a location where the conductive wire portion 613 is not present, specifically, between the one end OE1 and the one end OE2. The first bonding portion GL1B is provided to surround the conductive wire portion 613 with a spacing from the conductive wire portion 613. As understood from FIGS. 14 and 15, the conductive wire portion 613 is disposed between the first bonding portions GL1A and GL1B. The conductive wire portion 613 is provided to detect a state in which ink passes beyond the first bonding portion GL1A but does not pass beyond the first bonding portion GL1B. In the present specification, a state in which the ink passes beyond the bonding portion GL means a state in which the ink leaks from the bonding portion GL, and when the ink does not leak from the bonding portion GL even in a case where the ink comes into contact with the bonding portion GL and the ink penetrates into the bonding portion GL, it is regarded as a state in which the ink does not pass beyond the bonding portion GL. A state in which the ink passes beyond the first bonding portion GL1A but does not pass beyond the first bonding portion GL1B can be said to be a state in which the ink is present in the first space SP1A between the first bonding portions GL1A and GL1B, and can also be said to be a state in which there is a sign of ink leakage from the liquid ejecting head 30. The conductive wire portion 613 is an example of a “first detection portion A”. The first space SP1A is an example of a “first region A”, and the flow path plate Su4 is an example of a “flow path member”. The “first region A” may be a two-dimensional space, that is, a plane, or may be a three-dimensional space, but in the present specification, when simply referred to as a space, it indicates a three-dimensional space.

By providing the first space SP1A, when the ink passes beyond the first bonding portion GL1A, the ink leaking from the first bonding portion GL1A can be accommodated in the first space SP1A. Therefore, as compared with an aspect in which the first space SP1A is not provided, it is possible to delay a timing at which the ink leaks from the liquid ejecting head 30. Additionally, in the first embodiment, the first space SP1A is formed by cutting out the surface S42 in the Z1 direction, but the present disclosure is not limited thereto. For example, the first space SP1A may be formed by cutting out the surface S51 of the flow path plate Su5 in the Z2 direction. Further, the first space SP1A need not be provided.

In the example of FIG. 14, a width L1B of the first bonding portion GL1B is narrower than a width L1A of the first bonding portion GL1A. The width L1A can also be said to be a minimum distance from the supply flow path Sh1 to an inner peripheral side of the first space SP1A. In addition, the width L1B can also be said to be a minimum distance from an outer peripheral side of the first space SP1A to an outer peripheral side of the first bonding portion GL1B.

A state in which the ink does not pass beyond the first bonding portion GL1A means that the first bonding portion GL1A is not deteriorated to such an extent that ink leaks. Therefore, in the following description, a state in which the ink does not pass beyond the first bonding portion GL1A may be referred to as a “non-deteriorated state”. On the other hand, a state in which the ink passes beyond the first bonding portion GL1A but does not pass beyond the first bonding portion GL1B means that the ink is deteriorated to such an extent that ink leaks from the first bonding portion GL1A. Therefore, in the following description, a state in which the ink passes beyond the first bonding portion GL1A but does not pass beyond the first bonding portion GL1B may be referred to as a “deteriorated state”. Additionally, the non-deteriorated state and the deteriorated state may be collectively referred to as a “bonding portion deterioration state”.

In FIGS. 14 and 15, in order to prevent the drawings from being complicated, the shape of the conductive wire portion 613 is shown in a simplified manner. In FIGS. 14 and 15, vertical hatching is applied to portions where the wiring shape is simplified. The actual shape of the conductive wire portion 613 is a meandering shape in which an extending direction periodically changes, as shown in an enlarged region ER1 in which an end portion of the conductive wire portion 613 in the Y1 direction is enlarged in FIGS. 14 and 15. The conductive wire portion 613 is disposed to surround the first bonding portion GL1A while meandering.

A method of detecting a state in which the ink passes beyond the first bonding portion GL1A but does not pass beyond the first bonding portion GL1B will be described with reference to FIGS. 14 and 15. The measurement circuit 29 measures the magnitude of the current between the detection wiring 621 and the detection wiring 622. The control circuit 21 determines whether or not the ink is in a state of passing beyond the first bonding portion GL1A but not passing beyond the first bonding portion GL1B, based on the magnitude of the current measured by the measurement circuit 29. In contrast to the initial state of the liquid ejecting head 30 as shown in FIG. 14, in a state in which ink leaks from the first bonding portion GL1A as shown in FIG. 15, a part of the conductive wire portion 613 is short-circuited by the ink as shown in FIG. 15, and resistance between the detection wirings 621 and 622 decreases. Therefore, a current value between the detection wirings 621 and 622 in a state in which the ink leaks from the first bonding portion GL1A is greater than a current value between the detection wirings 621 and 622 in the initial state of the liquid ejecting head 30. Accordingly, the measurement circuit 29 measures the current value between the detection wiring 621 and the detection wiring 622 as the measurement process. Then, the measurement circuit 29 generates the measurement information JI indicating the measured current value and transmits the measurement information JI to the control circuit 21. The measurement information JI indicating the current value of the conductive wire portion 613 is an example of “state information” regarding the state of the conductive wire portion 613.

### 1-9. Functions of First Embodiment

The bonding portion deterioration state can be estimated by the detection mechanism 60A and the measurement circuit 29. In addition, it is preferable to replace the liquid ejecting head 30 before ink leaks from the liquid ejecting head 30. Therefore, in the ink jet system SYS according to the present embodiment, when the first bonding portion GL1A of the liquid ejecting head 30 is in the deteriorated state, a function of prompting the user U to replace the liquid ejecting head 30 is provided.

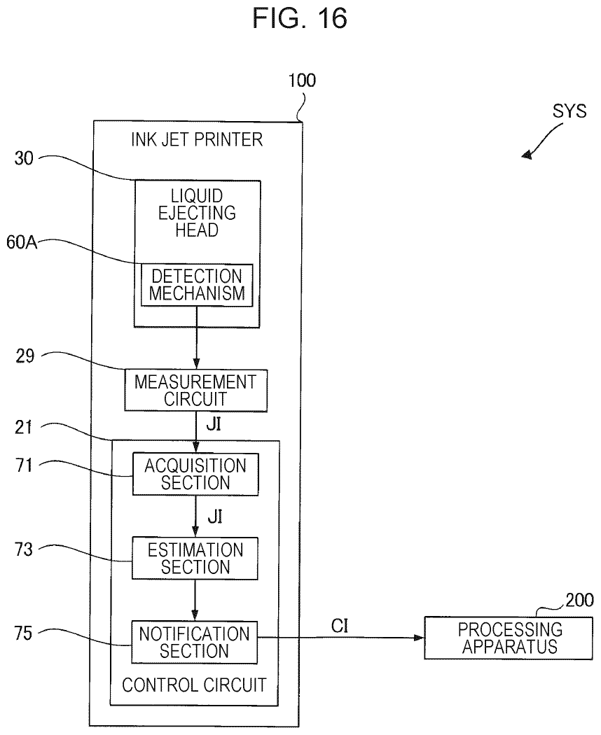

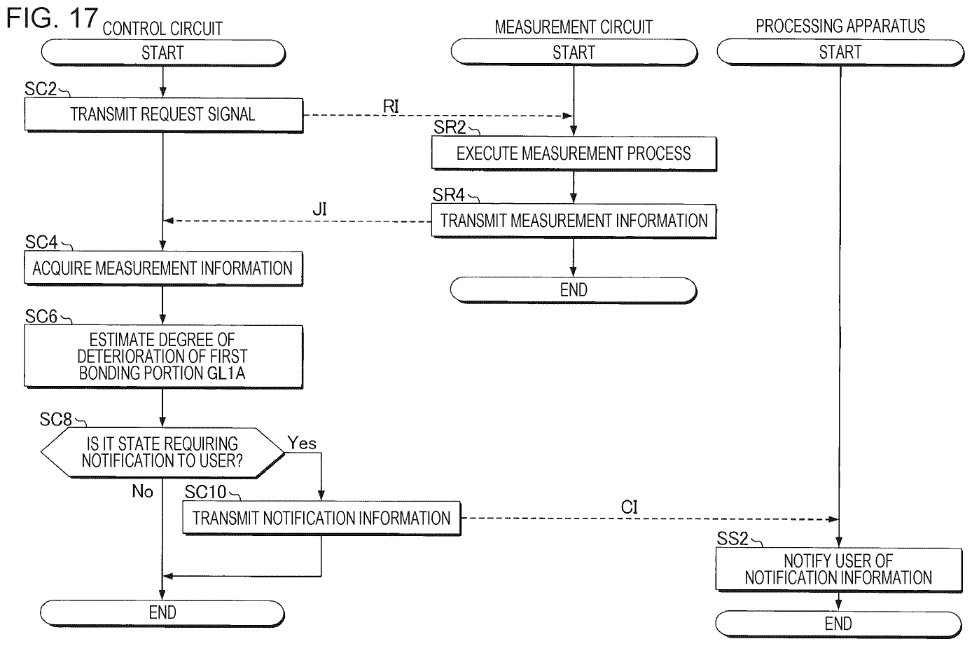

FIG. 16 is a diagram showing a function of the ink jet system SYS. FIG. 17 is a flowchart showing an operation of the ink jet system SYS. The control circuit 21 functions as an acquisition section 71, an estimation section 73, and a notification section 75 by executing the read control program PM2.

A series of processes shown in FIG. 17 are periodically executed. For example, the ink jet system SYS executes the series of processes shown in FIG. 17 every day, every week, or every month. However, the series of processes shown in FIG. 17 may be executed irregularly. For example, when the ink jet system SYS receives the image data Img from the processing apparatus 200, the ink jet system SYS may execute the series of processes shown in FIG. 17 before the printing process, or may execute the series of processes shown in FIG. 17 in response to an instruction from the user U.

In step SC2, the control circuit 21 transmits a request signal RI to the measurement circuit 29. After the end of processing in step SC2, the control circuit 21 waits for a response from the measurement circuit 29.

When the measurement circuit 29 receives the request signal RI, the measurement circuit 29 executes the measurement process in step SR2. After the end of processing in step SR2, the measurement circuit 29 transmits the measurement information JI indicating the measurement result to the control circuit 21 in step SR4. After the end of processing in step SR4, the measurement circuit 29 ends the series of processes shown in FIG. 17.

The control circuit 21 functions as the acquisition section 71 to acquire the measurement information JI from the measurement circuit 29 in step SC4. Next, the control circuit 21 functions as the estimation section 73 to estimate the degree of deterioration of the first bonding portion GL1A based on the measurement information JI in step SC6. Specifically, the control circuit 21 estimates that the state of the first bonding portion GL1A is the non-deteriorated state when the current value of the detection mechanism 60A is less than a predetermined threshold value. On the other hand, when the current value measured by the detection mechanism 60A is equal to or greater than the predetermined threshold value, the control circuit 21 estimates that the state of the first bonding portion GL1A is the deteriorated state. The predetermined threshold value is set in advance by the head manufacturer based on experiments and experience.

After the end of processing in step SC6, in step SC8, the control circuit 21 determines whether or not it is a state requiring a notification to the user U, based on an estimation result. More specifically, the control circuit 21 determines that it is a state requiring a notification to the user U when there is a liquid ejecting head 30 in which the state of the first bonding portion GL1A is the deteriorated state.

When a determination result in step SC8 is affirmative, in step SC10, the control circuit 21 functions as the notification section 75, generates the notification information CI based on the estimation result, and notifies the user U of the generated notification information CI. The notification information CI is information indicating that replacement of the liquid ejecting head 30 having a sign of ink leakage is prompted. For example, it is assumed that the estimation result estimates that the state of the first bonding portion GL1A is the deteriorated state. On this assumption, the notification information CI is a character string stating “There is a sign that the liquid ejecting head is failing. Specifically, there is a sign of ink leakage from this liquid ejecting head. Please replace the liquid ejecting head”. Additionally, the notification information CI is not limited to the character string. For example, the notification information CI may be information indicating an image in which a highlighted image that highlights the liquid ejecting head 30 having a sign of ink leakage is superimposed on an image indicating the head module 3. The highlighted image is, for example, an image in which a color of the liquid ejecting head 30 having a sign of ink leakage is made different from a color of the liquid ejecting head 30 having no sign of ink leakage, or an image in which a balloon pointing to the liquid ejecting head 30 having a sign of ink leakage is provided, the balloon including a character string stating “It is recommended to replace this liquid ejecting head”.

After the end of processing in step SC10, the control circuit 21 ends the series of processes shown in FIG. 17. Additionally, when the determination result in step SC8 is negative, the control circuit 21 also ends the series of processes shown in FIG. 17.

When the processing apparatus 200 receives the notification information CI, the control circuit 210 of the processing apparatus 200 notifies the user U of the notification information CI in step SS2. Specifically, the control circuit 210 displays the character string or the image indicated by the notification information CI on the display device 270.

In FIGS. 16 and 17, the control circuit 21 functions as the estimation section 73 and the notification section 75, but the present disclosure is not limited thereto. For example, the control circuit 21 may transmit the measurement information JI to the processing apparatus 200, and the control circuit 210 of the processing apparatus 200 may function as the estimation section 73 and the notification section 75.

### 1-10. Summary of First Embodiment

As described above, the liquid ejecting head 30 in the first embodiment includes the plurality of nozzles Nz that eject ink, the supply flow path Sh1 that communicates with one or more nozzles Nz among the plurality of nozzles Nz, the first bonding portion GL1A that defines the inner wall SY of the supply flow path Sh1 and is provided to surround the supply flow path Sh1, the first bonding portion GL1B that is provided to surround the first bonding portion GL1A, and the conductive wire portion 613 for detecting a state in which the ink passes beyond the first bonding portion GL1A but does not pass beyond the first bonding portion GL1B.

According to the first embodiment, since it is possible to detect a state in which the ink passes beyond the first bonding portion GL1A but does not pass beyond the first bonding portion GL1B by using the conductive wire portion 613, it is possible to detect a sign of ink leakage from the liquid ejecting head 30. The user U can know a time point at which a sign of ink leakage from the liquid ejecting head 30 is detected as an appropriate timing for replacing the liquid ejecting head 30.

In addition, the adhesive forming the first bonding portion GL1A and the adhesive forming the first bonding portion GL1B are of the same type, and the width L1B of the first bonding portion GL1B is narrower than the width L1A of the first bonding portion GL1A.

Since the adhesive forming the first bonding portion GL1A and the adhesive forming the first bonding portion GL1B are of the same type, it is possible to make deterioration conditions of the first bonding portions GL1A and GL1B the same for various inks. As a result of being able to make the deterioration conditions the same, in the first embodiment, it can be said that, as compared with an aspect in which the adhesives are of different types from each other, degrees of progression of deterioration of the first bonding portion GL1A and the first bonding portion GL1B upon contact with ink are close to each other. As compared with an aspect in which the width L1B is wider than the width L1A, it is possible to detect a sign of ink leakage from the liquid ejecting head 30 at a timing closer to a time point at which ink leaks from the liquid ejecting head 30. Accordingly, when the liquid ejecting head 30 is replaced at a time point at which it is detected that the first bonding portion GL1A is in the deteriorated state, it is possible to extend a usage period of the liquid ejecting head 30 as compared with an aspect in which the width L1B is wider than the width L1A.

In addition, the ink flowing through the supply flow path Sh1 has conductive properties, and the first detection portion A is the conductive wire portion 613 disposed in the first space SP1A between the first bonding portions GL1A and GL1B.

According to the first embodiment, by using a change in electrical resistance of the conductive wire portion 613 when the conductive wire portion 613 comes into contact with ink, it is possible to detect a sign of ink leakage from the liquid ejecting head 30.

In addition, the ink jet printer 100 includes the liquid ejecting head 30 and the control circuit 21. The control circuit 21 functions as the acquisition section 71 that acquires the measurement information JI and the estimation section 73 that estimates the degree of deterioration of the first bonding portion GL1A based on the measurement information JI.

According to the first embodiment, by estimating the degree of deterioration of the first bonding portion GL1A, it is possible to notify the user U that there is a sign of ink leakage in the liquid ejecting head 30. Therefore, it is possible to detect a sign of ink leakage from the liquid ejecting head 30 without destroying the liquid ejecting head 30.

The control circuit 21 further functions as the notification section 75. The notification section 75 issues a notification prompting the replacement of the liquid ejecting head 30, based on the estimation result of the degree of deterioration of the first bonding portion GL1A based on the measurement information JI.

According to the first embodiment, the user U can replace the liquid ejecting head 30 before ink leaks from the liquid ejecting head 30 by replacing the liquid ejecting head 30 in response to the notification prompting the replacement of the liquid ejecting head 30.

The notification section 75 may add lifetime information indicating a lifetime of the liquid ejecting head 30 to the notification information CI indicating prompting replacement of the liquid ejecting head 30 having a sign of ink leakage. The lifetime information is, for example, a character string stating “The expected failure date of the liquid ejecting head 30 is yyyy/mm/dd”. yyyy is a four-digit numerical value. mm is an integer from 1 to 12. dd is an integer from 1 to 31. In order to generate the lifetime information, the storage circuit 22 stores information indicating a date of start of use of the liquid ejecting head 30, information indicating a length of the width L1A of the first bonding portion GL1A, and information indicating a length of the width L1B of the first bonding portion GL1B. It is assumed that the notification information CI indicates that there is a sign of ink leakage in the liquid ejecting head 30. The notification section 75 calculates the lifetime of the liquid ejecting head 30 by using the following Equation (1).

$$Lifetime of the liquid ejecting head 30 = ( Current date - Date of start of use of the liquid ejecting head 30 ) \times ( Width L 1 A + Width L 1 B ) / Width L 1 A + Current date \qquad ( 1 )$$

When the lifetime information is generated, the notification section 75 may notify the user U of the notification information CI immediately after the lifetime information is generated, or may notify the user U of the notification information CI a predetermined number of days before the date indicated by the lifetime information.

### 2. Second Embodiment

A method of estimating the degree of deterioration of the first bonding portion GL1A is not limited to a method of providing the conductive wire portion 613. In a second embodiment, an adhesive that discolors upon contact with ink is used. The second embodiment will be described below. In the second embodiment, a third embodiment to be described below, and modification examples based on the second embodiment or the third embodiment, the ink need not have conductive properties.

### 2-1. Configuration and Operation of Second Embodiment

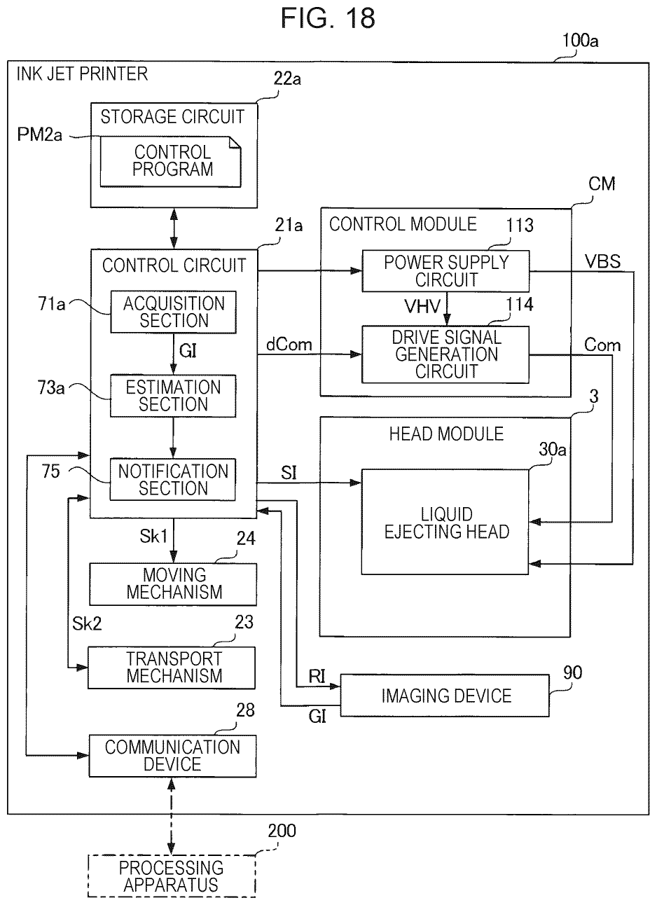

FIG. 18 is a block diagram showing a configuration example of an ink jet printer 100a in the second embodiment. The ink jet printer 100a includes a liquid ejecting head 30a instead of the liquid ejecting head 30, includes a control circuit 21a instead of the control circuit 21, includes a storage circuit 22a instead of the storage circuit 22, and includes an imaging device 90 instead of the measurement circuit 29.

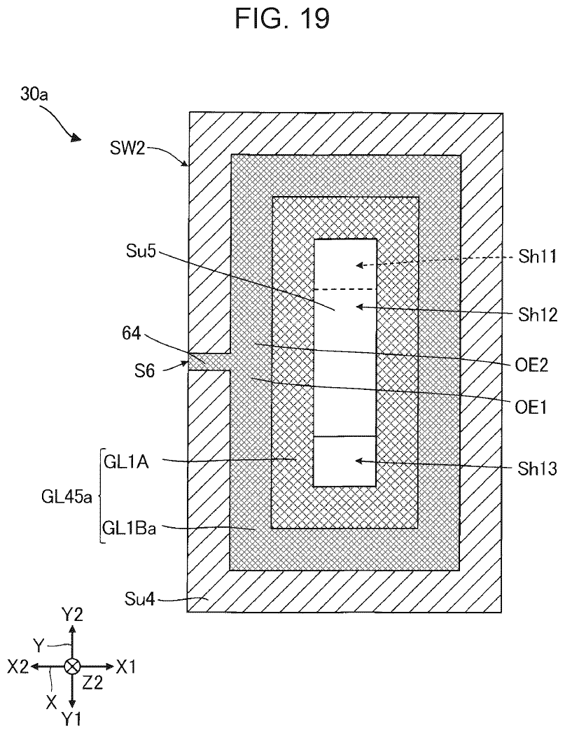

FIG. 19 is a view illustrating a first bonding portion GL1Ba. FIG. 19 shows a cross-section of the liquid ejecting head 30a taken along line a-a shown in FIG. 13.

A bonding portion GL45a in the second embodiment includes the first bonding portion GL1Ba instead of the first bonding portion GL1B. The first bonding portion GL1Ba is provided to surround the first bonding portion GL1A to be in close contact with the first bonding portion GL1A.

The first bonding portion GL1Ba includes a protruding portion 64. The protruding portion 64 is a portion protruding in the X2 direction from an annular portion of the first bonding portion GL1Ba that surrounds the first bonding portion GL1A. In the example of FIG. 19, a detection surface S6 of the protruding portion 64 that faces the X2 direction is flush with a wall surface SW2 of the flow path structure 33 that faces the X2 direction. However, the detection surface S6 need not be flush with the wall surface SW2 and may be recessed with respect to the wall surface SW2 to such an extent as to be visually recognizable from the outside of the flow path structure 33.

In the second embodiment, the flow path plate Su4 is an example of a “first flow path member”, the flow path plate Su5 is an example of a “second flow path member”, and the detection surface S6 which is a part of the first bonding portion GL1Ba is an example of a “first detection portion A”. That the detection surface S6 is disposed at a position recessed with respect to the wall surface SW2 to such an extent as to be visually recognizable from the outside of the flow path structure 33 is an example of “a part of the first detection portion A is disposed in the vicinity of an outer surface of the first flow path member”.

The first bonding portion GL1Ba has a property of discoloring upon contact with ink. A discoloration aspect in which discoloration occurs upon contact with ink has the following two aspects. A first discoloration aspect is an aspect in which a colorant of the adhesive changes upon contact with ink. For example, the adhesive forming the first bonding portion GL1Ba contains an anthocyanin colorant. The color of the anthocyanin colorant is red in an acidic state and blue in an alkaline state. Therefore, in the first discoloration aspect, at the time point of manufacturing the liquid ejecting head 30, when the liquid property of the ink is acidic, the head manufacturer forms the first bonding portion GL1Ba such that the first bonding portion GL1Ba becomes alkaline. On the other hand, when the liquid property of the ink is alkaline, the first bonding portion GL1Ba is formed such that the first bonding portion GL1Ba becomes acidic. As a result, since the anthocyanin colorant discolors when the first bonding portion GL1Ba comes into contact with ink, the first bonding portion GL1Ba has a property of discoloring upon contact with ink. A colorant that discolors depending on the liquid property is not limited to an anthocyanin colorant, and may be a flavonoid colorant.

A second discoloration aspect is an aspect in which the first bonding portion GL1Ba is transparent or translucent, and the first bonding portion GL1Ba discolors because of a color material contained in ink when the ink containing the color material penetrates into the first bonding portion GL1Ba.

In the second embodiment, a method of detecting a state in which the ink passes beyond the first bonding portion GL1A but does not pass beyond the first bonding portion GL1Ba will be described. Immediately after the liquid ejecting head 30a is filled with ink from the initial state of the liquid ejecting head 30a, only the first bonding portion GL1A is in contact with the ink, but since the first bonding portion GL1Ba is not in contact with the ink, the first bonding portion GL1Ba is not discolored. When the ink passes beyond the first bonding portion GL1A, the first bonding portion GL1Ba comes into contact with the ink, thereby causing the first bonding portion GL1Ba to discolor. When the first bonding portion GL1Ba is discolored, the detection surface S6 of the first bonding portion GL1Ba is also discolored.

The description returns to FIG. 18. The imaging device 90 images the detection surface S6. The imaging device 90 includes an imaging optical system and an imaging element. The imaging optical system is an optical system including at least one imaging lens, and may include various optical elements such as a prism, or may include a zoom lens, a focus lens, or the like. From the viewpoint that it is easy to image the detection surface S6 with the imaging element, it is preferable that the imaging optical system includes a wide-angle lens or a fisheye lens. The imaging element is, for example, a charge coupled device (CCD) image sensor, a complementary MOS (CMOS) image sensor, or the like. The imaging element captures an image via the imaging optical system and transmits image information GI indicating the captured image to the control circuit 21a.

In order for the imaging device 90 to be able to image the detection surface, a through-hole or a transparent member is provided in a portion of the side wall of the cover member 31 in the Y2 direction that overlaps the detection surface as viewed in the direction along the Y-axis, and the detection surface S6 can be visually recognized from the outside of the liquid ejecting head 30a. Additionally, the imaging device 90 may include a light source that irradiates the detection surface S6 in order to make an image obtained by capturing the detection surface S6 clearer.

The storage circuit 22a stores a control program PM2a instead of the control program PM2. As shown in FIG. 18, the control circuit 21a functions as an acquisition section 71a, an estimation section 73a, and the notification section 75 by executing the read control program PM2a.

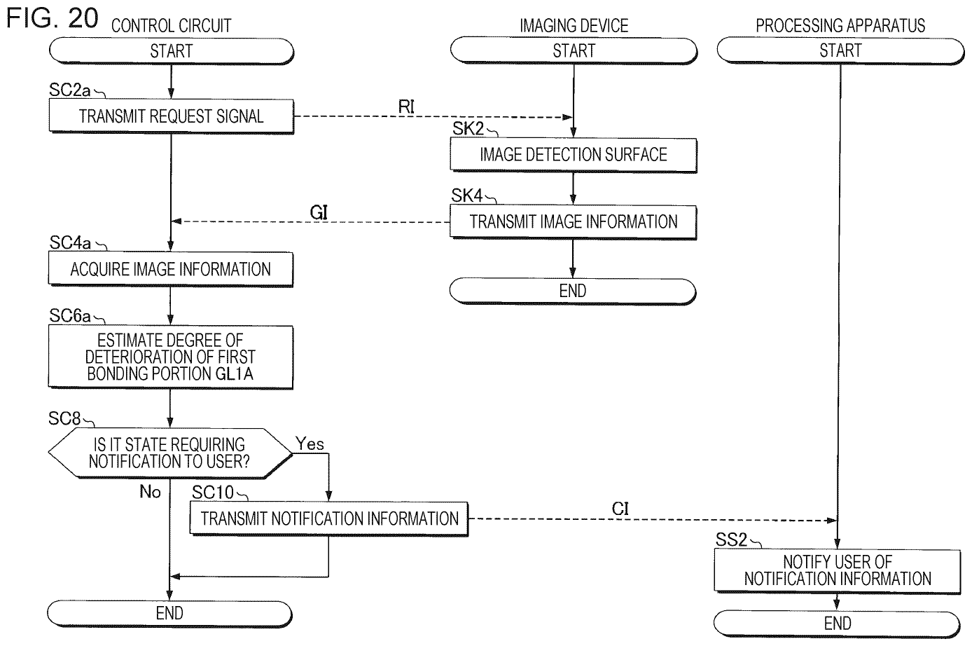

FIG. 20 is a flowchart showing an operation of the ink jet system SYS in the second embodiment. Hereinafter, only differences from the flowchart shown in FIG. 17 will be described.

In step SC2a, the control circuit 21a transmits the request signal RI to the imaging device 90. After the end of processing in step SC2a, the control circuit 21a waits for a response from the imaging device 90.

When the imaging device 90 receives the request signal RI, the imaging device 90 images the detection surface S6 in step SK2. Then, the imaging device 90 transmits the image information GI indicating the image obtained by capturing the detection surface S6 to the control circuit 21a in step SK4. After the end of processing in step SK4, the imaging device 90 ends a series of processes shown in FIG. 20.

The control circuit 21a functions as the acquisition section 71a to acquire the image information GI from the imaging device 90 in step SC4a. Next, the control circuit 21a functions as the estimation section 73a to estimate the degree of deterioration of the first bonding portion GL1A based on the image information GI in step SC6a. Specifically, the storage circuit 22a stores pre-discoloration image information indicating an image of the detection surface S6 before discoloration and post-discoloration image information indicating an image after discoloration. The control circuit 21a determines whether the image obtained by capturing the detection surface S6 is closer to an image indicated by the pre-discoloration image information or to an image indicated by the post-discoloration image information. When it is determined that the image obtained by capturing the detection surface is closer to the image indicated by the pre-discoloration image information, the control circuit 21a estimates that the state of the first bonding portion GL1A is the non-deteriorated state. On the other hand, when it is determined that the image obtained by capturing the detection surface is closer to the image indicated by the post-discoloration image information, the control circuit 21a estimates that the state of the first bonding portion GL1A is the deteriorated state. The pre-discoloration image information and the post-discoloration image information are stored in advance in the storage circuit 22a by the head manufacturer based on experiments.

In the second embodiment, the image information GI indicating the image obtained by capturing the detection surface is an example of “state information” regarding the state of the detection surface S6.

### 2-2. Summary of Second Embodiment

As described above, the liquid ejecting head 30a in the second embodiment further includes the flow path plates Su4 and Su5 constituting the supply flow path Sh1. The first bonding portions GL1A and GL1Ba bond the flow path plates Su4 and Su5. The detection surface S6, which is a part of the first bonding portion GL1Ba, as the first detection portion A in the second embodiment is disposed in the vicinity of the wall surface SW2 of the flow path plate Su4. The first bonding portion GL1Ba has a property of discoloring upon contact with the ink flowing through the supply flow path Sh1.

According to the second embodiment, when the ink leaks from the first bonding portion GL1A and the ink comes into contact with the first bonding portion GL1Ba, a sign of ink leakage from the liquid ejecting head 30a can be detected by discoloration of the first bonding portion GL1Ba.

In addition, the ink jet printer 100a includes the liquid ejecting head 30a and the control circuit 21a. The control circuit 21a functions as the acquisition section 71a that acquires the image information GI from the imaging device 90 and the estimation section 73a that estimates the degree of deterioration of the first bonding portion GL1A based on the image information GI.

According to the second embodiment, similarly to the first embodiment, it is possible to notify the user U that there is a sign of ink leakage in the liquid ejecting head 30a.

In the second embodiment, the ink jet printer 100a need not include the imaging device 90. The user U can detect a sign of ink leakage from the liquid ejecting head 30a by directly visually observing the detection surface S6. Additionally, the liquid ejecting head 30a may include both the detection surface S6 for visual observation by the user U and the detection surface S6 for imaging by the imaging device 90. Further, the detection surface S6 may be provided over the entire periphery of the wall surface SW2 of the flow path plate Su4 in plan view.

### 3. Third Embodiment

In the second embodiment, the sign of ink leakage from the liquid ejecting head 30a is detected by the discoloration of the first bonding portion GL1Ba, but the present disclosure is not limited thereto. In a third embodiment, a configuration is employed in which ink that passes beyond the first bonding portion GL1A can be directly visually recognized.

### 3-1. Configuration and Operation of Third Embodiment

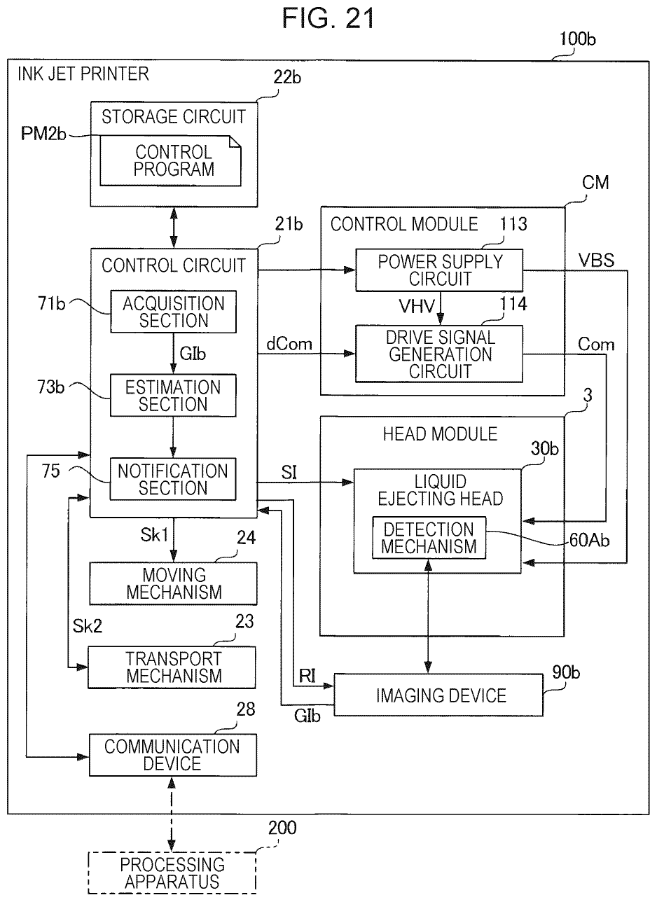

FIG. 21 is a block diagram showing a configuration example of an ink jet printer 100b in the third embodiment. The ink jet printer 100b includes a liquid ejecting head 30b instead of the liquid ejecting head 30a, includes a control circuit 21b instead of the control circuit 21a, includes a storage circuit 22b instead of the storage circuit 22a, and includes an imaging device 90b instead of the imaging device 90. The liquid ejecting head 30b includes a detection mechanism 60Ab.

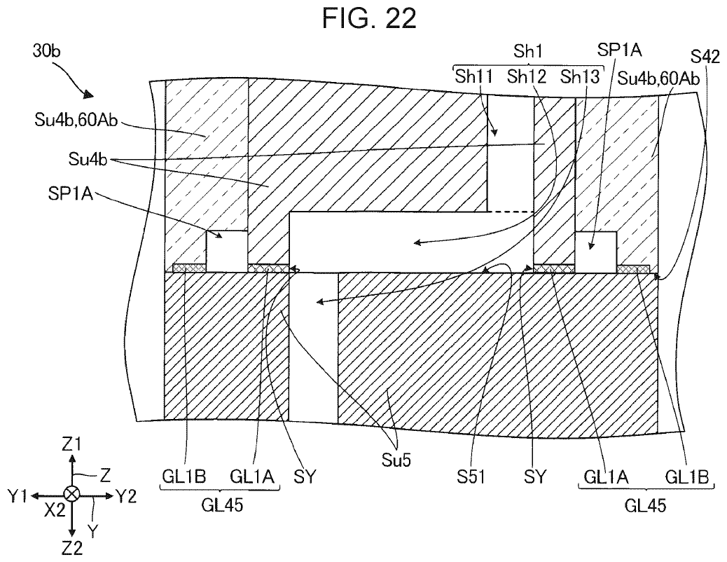

FIG. 22 is a view illustrating the detection mechanism 60Ab. In FIG. 22, the region RG1 shown in FIG. 12 is shown in an enlarged manner with the liquid ejecting head 30 replaced with the liquid ejecting head 30b.

The liquid ejecting head 30b includes a flow path plate Su4b instead of the flow path plate Su4. The flow path plate Su4b includes the detection mechanism 60Ab. The detection mechanism 60Ab is a light-transmitting portion having light-transmitting properties, the light-transmitting portion being provided in the flow path plate Su4b to make the first space SP1A visually recognizable from the outside. In the present specification, having light-transmitting properties means that a member having a thickness of 10 mm or less has a visible light transmittance of 50% or greater. However, it is preferable that the transmittance is high, and specifically, it is preferable that a member having a thickness of 10 mm or less has a visible light transmittance of 70% or greater, and more preferably 90% or greater. The member having light-transmitting properties is formed of glass and transparent resin materials such as a transparent epoxy resin or a transparent acrylic resin. In addition, as a method of manufacturing the flow path plate Su4b, for example, the detection mechanism 60Ab, which is the light-transmitting portion, and a non-light-transmitting resin may be integrated by insert molding, or the detection mechanism 60Ab may be bonded to the non-light-transmitting resin using some kind of adhesive.

In the third embodiment, the flow path plate Su4b is an example of a “flow path member”, and the first space SP1A defined by the flow path plate Su4b is an example of a “first region A”.

As understood from FIG. 22, in plan view, the detection mechanism 60Ab overlaps the first space SP1A and the first bonding portion GL1B. Therefore, the detection mechanism 60Ab has an annular shape, similarly to the first space SP1A and the first bonding portion GL1B.

When ink passes beyond the first bonding portion GL1A, the ink leaking from the first bonding portion GL1A is accommodated in the first space SP1A. Therefore, by viewing the detection mechanism 60Ab in the direction perpendicular to the Z-axis, it is possible to determine whether or not ink passes beyond the first bonding portion GL1A depending on whether or not ink is present in the first space SP1A.

Although not shown in FIG. 22, similarly to the first embodiment, in the third embodiment, the adhesive forming the first bonding portion GL1A and the adhesive forming the first bonding portion GL1B may be of the same type or different types. The width of the first bonding portion GL1B is narrower than the width of the first bonding portion GL1A.

The description returns to FIG. 21. The imaging device 90b images the detection mechanism 60Ab in the direction perpendicular to the Z-axis and transmits image information GIb indicating the captured image to the control circuit 21b.

In order for the imaging device 90b to be able to image the first space SP1A, similarly to the second embodiment, a through-hole or a transparent member is provided in a portion of the side wall of the cover member 31 in the Y2 direction that overlaps the first space SP1A as viewed in the direction along the Y-axis, and the first space SP1A can be visually recognized from the outside of the liquid ejecting head 30b. Additionally, the imaging device 90b may include a light source that irradiates the first space SP1A in order to make the image obtained by capturing the first space SP1A clearer.

The storage circuit 22b stores a control program PM2b instead of the control program PM2a. As shown in FIG. 21, the control circuit 21b functions as an acquisition section 71b, an estimation section 73b, and the notification section 75 by executing the read control program PM2b.

The acquisition section 71b acquires the image information GIb from the imaging device 90b. The estimation section 73b estimates the degree of deterioration of the first bonding portion GL1A based on the image information GIb. Specifically, the storage circuit 22b stores pre-deterioration image information indicating an image obtained by capturing the detection mechanism 60Ab in the direction perpendicular to the Z-axis in a state in which no ink is present in the first space SP1A, and post-deterioration image information indicating an image obtained by capturing the detection mechanism 60Ab in the direction perpendicular to the Z-axis in a state in which ink is present in the first space SP1A. The estimation section 73b determines whether the image obtained by capturing the detection mechanism 60Ab is closer to the image indicated by the pre-deterioration image information or to the image indicated by the post-deterioration image information. When it is determined that the image indicated by the image information GIb is closer to the image indicated by the pre-deterioration image information, the estimation section 73b estimates that the state of the first bonding portion GL1A is the non-deteriorated state. On the other hand, when it is determined that the image indicated by the image information GIb is closer to the image indicated by the post-deterioration image information, the estimation section 73b estimates that the state of the first bonding portion GL1A is the deteriorated state. The pre-deterioration image information and the post-deterioration image information are stored in the storage circuit 22b in advance by the head manufacturer based on experiments.

In the third embodiment, the image information GIb obtained by imaging the detection mechanism 60Ab in the direction perpendicular to the Z-axis is an example of “state information” regarding the state of the detection mechanism 60Ab.

### 3-2. Summary of Third Embodiment

As described above, the liquid ejecting head 30b in the third embodiment further includes the flow path plate Su4b that defines the first space SP1A between the first bonding portions GL1A and GL1B, and the detection mechanism 60Ab, which is the first detection portion A in the third embodiment, is a light-transmitting portion having light-transmitting properties, the light-transmitting portion being provided in the flow path plate Su4b to make the first space SP1A visually recognizable from the outside.

When ink leaks from the first bonding portion GL1A, by making the first space SP1A visually recognizable from the outside, ink in the first space SP1A can be visually recognized, thereby detecting a sign of ink leakage from the liquid ejecting head 30b.

In addition, the ink jet printer 100b includes the liquid ejecting head 30b and the control circuit 21b. The control circuit 21b functions as the acquisition section 71b that acquires the image information GIb from the imaging device 90b and the estimation section 73b that estimates the degree of deterioration of the first bonding portion GL1A based on the image information GIb.

According to the third embodiment, similarly to the first embodiment, it is possible to notify the user U of the liquid ejecting head 30b in which there is a sign of ink leakage in the liquid ejecting head 30b.

In the third embodiment, the ink jet printer 100b need not include the imaging device 90b. The user U can determine whether or not ink is present in the first space SP1A by directly visually observing the detection mechanism 60Ab of the liquid ejecting head 30b, thereby detecting a sign of ink leakage from the liquid ejecting head 30b.

In the third embodiment, the liquid ejecting head 30b need not include the first space SP1A. Even when the first space SP1A is not provided, it is possible to detect a sign of ink leakage from the liquid ejecting head 30b by determining whether or not ink is present in a region between the first bonding portion GL1A and the first bonding portion GL1B. The region between the first bonding portions GL1A and GL1B is an example of a “first region A”. However, since providing the first space SP1A facilitates confirmation of ink, it is preferable that the liquid ejecting head 30b includes the first space SP1A.

In addition, in the third embodiment, a part of the flow path plate Su4b is the detection mechanism 60Ab, that is, the light-transmitting portion, but the entirety of the flow path plate Su4b may be the light-transmitting portion. However, when the ink is UV ink, ink in the supply flow path Sh1 may be cured when the entirety of the flow path plate Su4b is the light-transmitting portion. Therefore, when the ink is UV ink, in plan view, it is preferable that a portion of the flow path plate Su4b that overlaps the supply flow path Sh1 and the first bonding portion GL1A is not a light-transmitting portion.

### 4. Modification Examples

Each of the aspects exemplified above can be variously modified. Specific modification aspects that can be applied to each of the aspects mentioned above will be exemplified below. Two or more aspects optionally selected from the following examples can be combined as appropriate within a range in which the aspects are not mutually contradictory.

### 4-1. First Modification Example and Second Modification Example

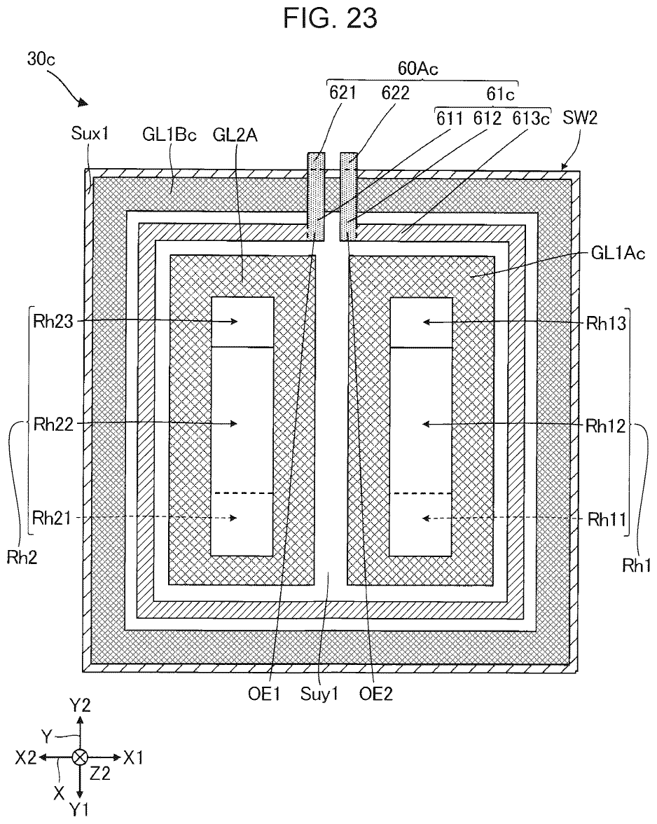

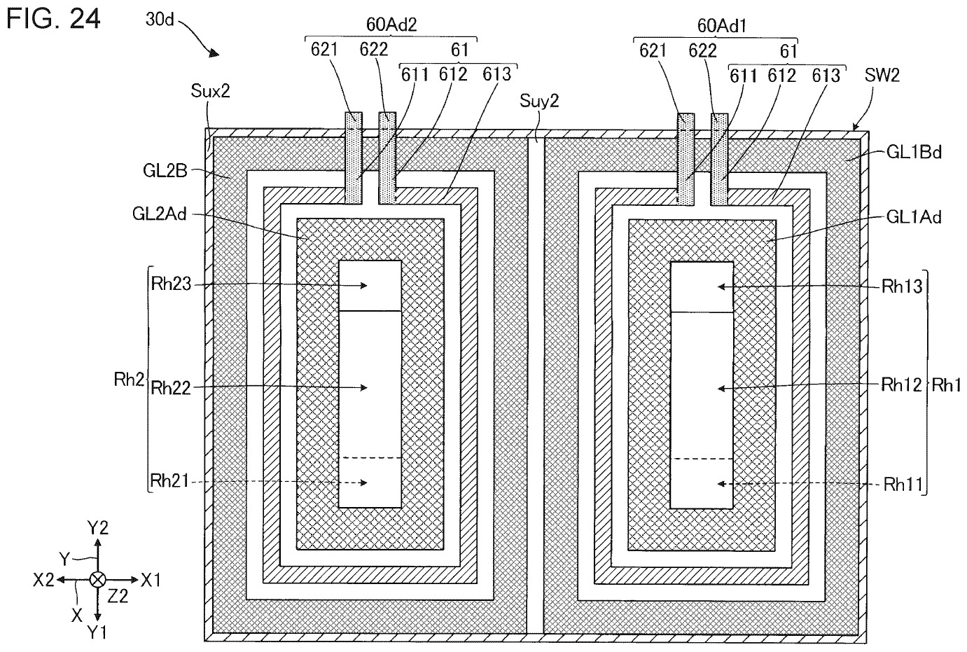

In the first embodiment, when the flow path member includes a plurality of flow paths, a first detection aspect in which a plurality of flow paths are provided to be surrounded by one detection mechanism 60A and a second detection aspect in which each of the plurality of flow paths is provided to be surrounded by each of the detection mechanisms 60A are considered. Hereinafter, the first detection aspect will be described with reference to FIG. 23 as a first modification example, and the second detection aspect will be described with reference to FIG. 24 as a second modification example.

FIG. 23 is a view illustrating a detection mechanism 60Ac in the first modification example. A liquid ejecting head 30c in the first modification example includes a detection mechanism 60Ac instead of the detection mechanism 60A. A first flow path Rh1 and a second flow path Rh2 are formed in flow path plates Sux1 and Suy1 shown in FIG. 23. The flow path plate Sux1 is any one of the flow path plates Su1 to Su4. The flow path plate Suy1 is a member that is positioned in the Z2 direction with respect to the flow path plate Sux1 and that is joined to the flow path plate Sux1.

The first flow path Rh1 and the second flow path Rh2 are any two flow paths provided in the laminate 333. However, in the first modification example, the ink flowing through the first flow path Rh1 and the second flow path Rh2 is of the same type. In the example of FIG. 23, the first flow path Rh1 includes a vertical flow path Rh11 extending in the direction along the Z-axis, a horizontal flow path Rh12 extending in the direction perpendicular to the Z-axis, and a vertical flow path Rh13 extending in the direction along the Z-axis. Similarly, the second flow path Rh2 includes a vertical flow path Rh21 extending in the direction along the Z-axis, a horizontal flow path Rh22 extending in the direction perpendicular to the Z-axis, and a vertical flow path Rh23 extending in the direction along the Z-axis. In FIG. 23, the positions of the vertical flow path Rh11 and the vertical flow path Rh21 are shown in order to show a positional relationship. Additionally, in the example of FIG. 23, an end portion of the vertical flow path Rh11 in the Z2 direction communicates with an end portion of the horizontal flow path Rh12 in the Y1 direction. An end portion of the horizontal flow path Rh12 in the Y2 direction communicates with an end portion of the vertical flow path Rh13 in the Z1 direction. Further, an end portion of the vertical flow path Rh21 in the Z2 direction communicates with an end portion of the horizontal flow path Rh22 in the Y1 direction. An end portion of the horizontal flow path Rh22 in the Y2 direction communicates with an end portion of the vertical flow path Rh23 in the Z1 direction. In the example of FIG. 23, the horizontal flow path Rh12 and the horizontal flow path Rh22 both extend along the Y-axis, but the present disclosure is not limited thereto, and the horizontal flow path Rh12 and the horizontal flow path Rh22 may extend in a direction intersecting the Y-axis. Furthermore, the first flow path Rh1 need not include the horizontal flow path Rh12. Similarly, the second flow path Rh2 need not include the horizontal flow path Rh22. In addition, the first flow path Rh1 and the second flow path Rh2 may include a distribution flow path that distributes to a plurality of flow paths, or may include a merging flow path in which a plurality of flow paths merge.

The first flow path Rh1 and the second flow path Rh2 may communicate with one or more identical nozzles Nz among the plurality of nozzles Nz provided in the liquid ejecting head 30c, or may communicate with one or more different nozzles Nz. In an example in which the ink flowing in the first flow path Rh1 and the second flow path Rh2 is of the same type and the first flow path Rh1 and the second flow path Rh2 communicate with one or more identical nozzles Nz, the first flow path Rh1 is a supply flow path through which ink is supplied to one or more nozzles Nz, and the second flow path Rh2 is a collection flow path through which ink is collected from the one or more nozzles Nz to which the ink is supplied through the first flow path Rh1. In the first modification example, the first flow path Rh1 is an example of a “first flow path”, and the second flow path Rh2 is an example of a “second flow path”.

The flow path plates Sux1 and Suy1 are joined to each other by a first bonding portion GL1Ac, a second bonding portion GL2A, and a first bonding portion GL1Bc. The first bonding portion GL1Ac defines an inner wall of the first flow path Rh1 and is provided to surround the first flow path Rh1. The second bonding portion GL2A defines an inner wall of the second flow path Rh2 and is provided to surround the second flow path Rh2. The first bonding portion GL1Bc is provided to surround the first bonding portion GL1Ac and the second bonding portion GL2A with a spacing from the first bonding portion GL1Ac and the second bonding portion GL2A.

The detection mechanism 60Ac includes a detection conductive wire 61c instead of the detection conductive wire 61. The detection conductive wire 61c includes a conductive wire portion 613c instead of the conductive wire portion 613. The conductive wire portion 613c is provided to detect a state in which ink passes beyond at least one of the first bonding portion GL1Ac and the second bonding portion GL2A but does not pass beyond the first bonding portion GL1Bc. As understood from FIG. 23, the conductive wire portion 613c has a meandering shape, similarly to the conductive wire portion 613. The conductive wire portion 613c is disposed to surround the first bonding portion GL1Ac and the second bonding portion GL2A while meandering. In the first modification example, the conductive wire portion 613c is an example of a “first detection portion A”. The second bonding portion GL2A is an example of a “second bonding portion A”.

A state in which ink does not pass beyond both the first bonding portion GL1Ac and the second bonding portion GL2A means that the first bonding portion GL1Ac and the second bonding portion GL2A are not deteriorated to such an extent that ink leaks. A state in which ink passes beyond at least one of the first bonding portion GL1Ac and the second bonding portion GL2A means that at least one of the first bonding portion GL1Ac and the second bonding portion GL2A is deteriorated to such an extent that ink leaks. Ink leaks from at least one of the first bonding portion GL1Ac and the second bonding portion GL2A, and the leaked ink comes into contact with the conductive wire portion 613c, whereby the current value between the detection wirings 621 and 622 increases.

As described above, in the first modification example, the liquid ejecting head 30c further includes the second flow path Rh2 that is different from the first flow path Rh1 and that communicates with one or more nozzles Nz among the plurality of nozzles Nz, and the second bonding portion GL2A that defines the inner wall of the second flow path Rh2 and that is provided to surround the second flow path Rh2. The conductive wire portion 613c, which is the first detection portion A, is provided to detect a state in which ink passes beyond at least one of the first bonding portion GL1Ac and the second bonding portion GL2A but does not pass beyond the first bonding portion GL1Bc. The first bonding portion GL1Bc is provided to surround the first bonding portion GL1Ac and the second bonding portion GL2A with a spacing from the first bonding portion GL1Ac and the second bonding portion GL2A.

According to the first modification example, as compared with a second modification example in which the conductive wire portion 613c, which is the first detection portion A, is provided in each of the first flow path Rh1 and the second flow path Rh2, the number of conductive wire portions 611 and 612 and detection wirings 621 and 622 to be disposed can be reduced. Additionally, even when ink leaks from both the first bonding portion GL1Ac and the second bonding portion GL2A, since the ink flowing in the first flow path Rh1 and the second flow path Rh2 is the same, it is possible to prevent a situation in which different types of ink are mixed.

FIG. 24 is a view illustrating detection mechanisms 60Ad1 and 60Ad2 in the second modification example. A liquid ejecting head 30d in the second modification example includes the detection mechanisms 60Ad1 and 60Ad2 instead of the detection mechanism 60Ac. The first flow path Rh1 and the second flow path Rh2 are formed in flow path plates Sux2 and Suy2 shown in FIG. 24, similarly to the first modification example. The flow path plate Sux2 is any one of the flow path plates Su1 to Su4. The flow path plate Suy2 is a member that is positioned in the Z2 direction with respect to the flow path plate Sux2 and is joined to the flow path plate Sux2.

In the second modification example, the type of ink flowing in the first flow path Rh1 and the second flow path Rh2 may be different. In the second modification example, the first flow path Rh1 is an example of a “first flow path”, and the second flow path Rh2 is an example of a “second flow path”.

The flow path plates Sux2 and Suy2 are joined to each other by first bonding portions GL1Ad and GL1Bd and second bonding portions GL2Ad and GL2B. The first bonding portion GL1Ad defines the inner wall of the first flow path Rh1 and is provided to surround the first flow path Rh1. The first bonding portion GL1Bd is provided to surround the first bonding portion GL1Ad with a spacing from the first bonding portion GL1Ad. The second bonding portion GL2Ad defines the inner wall of the second flow path Rh2 and is provided to surround the second flow path Rh2. The second bonding portion GL2B is provided to surround the second bonding portion GL2Ad with a spacing from the second bonding portion GL2Ad.

The detection mechanism 60Ad1 is provided for the first flow path Rh1, and the detection mechanism 60Ad2 is provided for the second flow path Rh2. Specifically, the conductive wire portion 613 of the detection mechanism 60Ad1 is provided to detect a state in which ink passes beyond the first bonding portion GL1Ad but does not pass beyond the first bonding portion GL1Bd. The conductive wire portion 613 of the detection mechanism 60Ad1 is provided to surround the first bonding portion GL1Ad. The conductive wire portion 613 of the detection mechanism 60Ad2 is provided to detect a state in which ink passes beyond the second bonding portion GL2Ad but does not pass beyond the second bonding portion GL2B. The conductive wire portion 613 of the detection mechanism 60Ad2 is provided to surround the second bonding portion GL2Ad. In the second modification example, the conductive wire portion 613 of the detection mechanism 60Ad1 is an example of a “first detection portion A”, and the conductive wire portion 613 of the detection mechanism 60Ad2 is an example of a “second detection portion”. The second bonding portion GL2B is an example of a “second bonding portion B”.

As described above, the liquid ejecting head 30d in the second modification example further includes the second flow path Rh2 that is different from the first flow path Rh1 and that communicates with one or more nozzles Nz among the plurality of nozzles Nz, the second bonding portion GL2Ad that defines the inner wall of the second flow path Rh2 and that is provided to surround the second flow path Rh2, the second bonding portion GL2B that is provided to surround the second bonding portion GL2Ad with a spacing from the second bonding portion GL2Ad, and the conductive wire portion 613 of the detection mechanism 60Ad2, which is the second detection portion for detecting a state in which ink passes beyond the second bonding portion GL2Ad but does not pass beyond the second bonding portion GL2B.

In the first modification example, when the types of ink flowing through the first flow path Rh1 and the second flow path Rh2 are different from each other, different types of ink are mixed when the ink leaks from both the first bonding portion GL1Ac and the second bonding portion GL2A. When the mixed ink flows back into either the first flow path Rh1 or the second flow path Rh2, the color of the ink ejected from the nozzle Nz changes, and the quality of the image formed on the medium PP deteriorates. On the other hand, in the second modification example, even when ink leaks from the first bonding portion GL1Ad, ink leakage is suppressed by the first bonding portion GL1Bd. Similarly, even when ink leaks from the second bonding portion GL2Ad, ink leakage is suppressed by the second bonding portion GL2B. Therefore, in the second modification example, even when ink leaks from both the first bonding portion GL1Ad and the second bonding portion GL2Ad, mixing of different types of ink can be suppressed. Accordingly, according to the second modification example, as compared with the first modification example in which the common first detection portion A is provided for the first flow path Rh1 and the second flow path Rh2, even when the types of ink flowing through the first flow path Rh1 and the second flow path Rh2 are different from each other, it is possible to detect a sign of ink leakage from the liquid ejecting head 30d while maintaining the quality of the image formed on the medium PP.

In addition, in the example shown in FIG. 24, each of the first bonding portion GL1Bd and the second bonding portion GL2B is independent, but a part of the first bonding portion GL1Bd and the second bonding portion GL2B may be common. In the example shown in FIG. 24, a portion of the first bonding portion GL1Bd in the X2 direction and a portion of the second bonding portion GL2B in the X1 direction may be common.

Although an aspect to which the first modification example and the second modification example are applied to the first embodiment is described, the first modification example can also be applied to each of the second embodiment and the third embodiment, and the second modification example can also be applied to each of the second embodiment and the third embodiment.

### 4-2. Third Modification Example

In a third modification example, it is possible to detect a sign of ink leakage from the liquid ejecting head 30 in multiple stages.

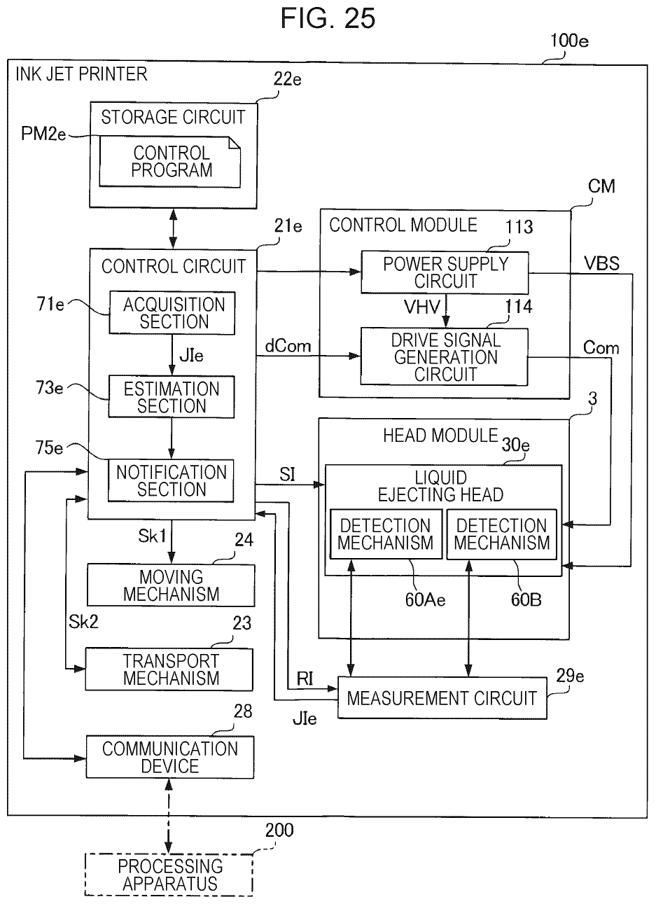

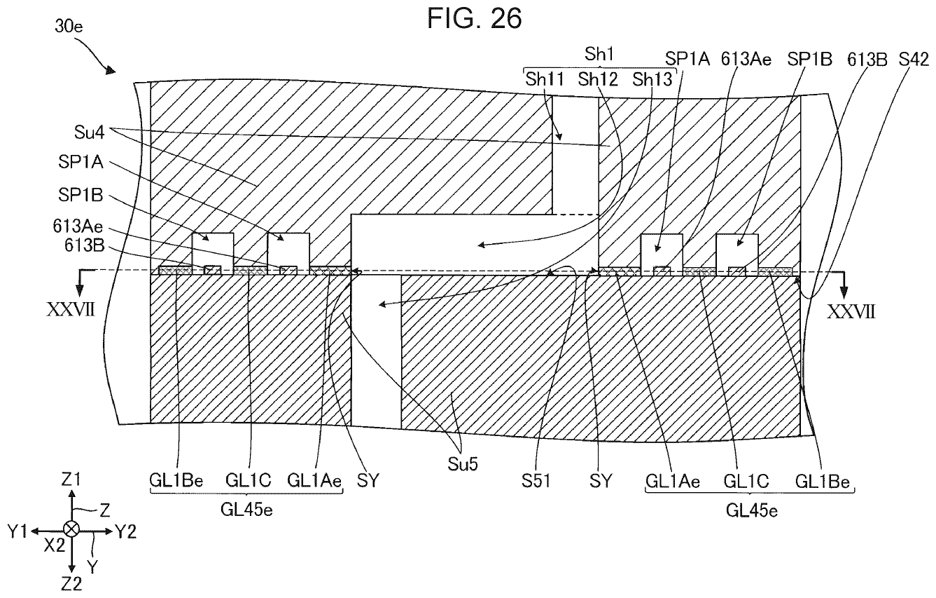

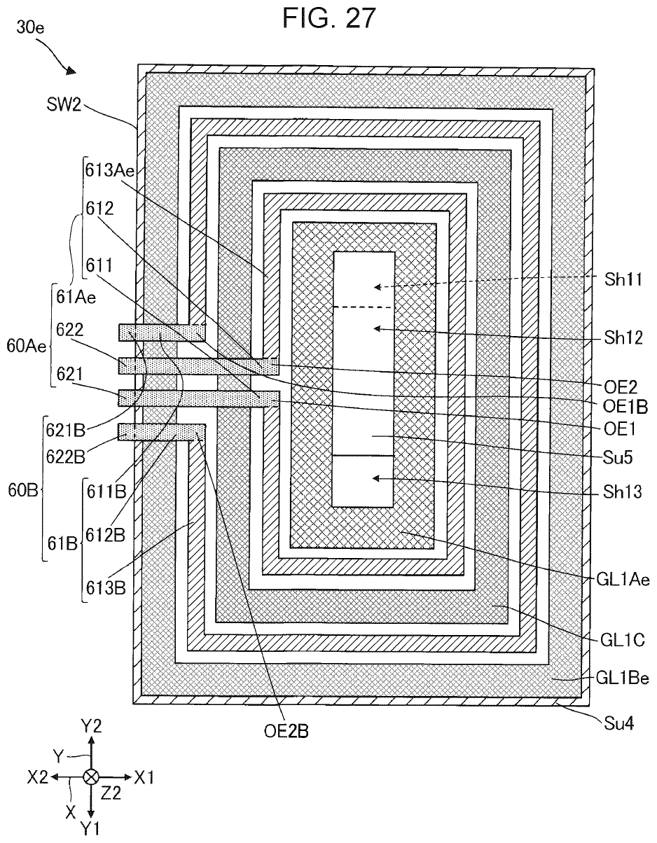

FIG. 25 is a block diagram showing a configuration example of an ink jet printer 100e in the third modification example. The ink jet printer 100e includes a liquid ejecting head 30e instead of the liquid ejecting head 30, includes a control circuit 21e instead of the control circuit 21, includes a storage circuit 22e instead of the storage circuit 22, and includes a measurement circuit 29e instead of the measurement circuit 29. The liquid ejecting head 30e includes detection mechanisms 60Ae and 60B instead of the detection mechanism 60A. The detection mechanisms 60Aa and 60B will be described with reference to FIGS. 26 and 27.

FIGS. 26 and 27 are views illustrating the detection mechanism 60Ae and the detection mechanism 60B. In FIG. 26, the region RG1 shown in FIG. 12 is shown in an enlarged manner with the liquid ejecting head 30 replaced with the liquid ejecting head 30e in the third modification example. FIG. 27 shows a cross-section of the liquid ejecting head 30e taken along line XXVII-XXVII shown in FIG. 26.

In the third modification example, the flow path plates Su4 and Su5 are joined by a bonding portion GL45e. The bonding portion GL45e includes a first bonding portion GL1C in addition to first bonding portions GL1Ae and GL1Be. The first bonding portion GL1C is disposed between the first bonding portions GL1Ae and GL1Be and is provided to surround the first bonding portion GL1Ae. In the third modification example, the first bonding portion GL1Ae is an example of a “first bonding portion A”, the first bonding portion GL1Be is an example of a “first bonding portion B”, and the first bonding portion GL1C is an example of a “first bonding portion C”.

The detection mechanism 60Ae includes a detection conductive wire 61Ae instead of the detection conductive wire 61. The detection conductive wire 61Ae includes a conductive wire portion 613Ae instead of the conductive wire portion 613. The conductive wire portion 613Ae is provided to detect a state in which ink passes beyond the first bonding portion GL1Ae but does not pass beyond the first bonding portion GL1C. As understood from FIGS. 26 and 27, the conductive wire portion 613Ae is disposed between the first bonding portions GL1Ae and GL1C. In the third modification example, the conductive wire portion 613Ae is an example of a “first detection portion A”.

The detection mechanism 60B includes a detection conductive wire 61B and detection wirings 621B and 622B. The detection conductive wire 61B is disposed on the surface S51. The detection conductive wire 61B includes conductive wire portions 611B, 612B, and 613B. The conductive wire portions 611B and 612B are parallel to the conductive wire portions 611 and 612, specifically, extend in the direction along the X-axis. As shown in FIG. 27, the conductive wire portions 611 and 612 are disposed between the conductive wire portions 611B and 612B. An end portion of the conductive wire portion 611B in the X1 direction is coupled to one end OE1B of the conductive wire portion 613B. An end portion of the conductive wire portion 612B in the X1 direction is coupled to one end OE2B of the conductive wire portion 613B. An end portion of the conductive wire portion 611B in the X2 direction is coupled to one end of the detection wiring 621B. An end portion of the conductive wire portion 612B in the X2 direction is coupled to one end of the detection wiring 622B. The detection wirings 621B and 622B function as lead-out wires of the detection conductive wire 61B. The detection wirings 621B and 622B are coupled to the measurement circuit 29e via a wiring member (not shown).

As understood from FIG. 26, the conductive wire portion 613B is accommodated in a first space SP1B formed by cutting out the surface S42 in the Z1 direction. As understood from FIGS. 26 and 27, the conductive wire portion 613B is disposed between the first bonding portions GL1C and GL1Be. In the third modification example, the conductive wire portion 613B is an example of a “first detection portion B”.

The description returns to FIG. 25. The measurement circuit 29e measures a current value between the detection wirings 621 and 622 of the detection mechanism 60Ae and a current value between the detection wirings 621B and 622B of the detection mechanism 60B. The measurement circuit 29e transmits measurement information JIe indicating a measurement result to the control circuit 21e.

The storage circuit 22e stores a control program PM2e instead of the control program PM2. As shown in FIG. 25, the control circuit 21e functions as an acquisition section 71e, an estimation section 73e, and a notification section 75e by executing the read control program PM2e.

The acquisition section 71e acquires the measurement information JIe from the control circuit 21e. The estimation section 73e estimates the degree of deterioration of the first bonding portion GL1Ae and the degree of deterioration of the first bonding portion GL1C based on the measurement information JIe. As understood from FIG. 27, a length of the wiring from the detection wiring 621 to 622 and a length of the wiring from the detection wiring 621B to 622B are different from each other. Therefore, that is, in the initial state of the liquid ejecting head 30e, a resistance value between the detection wirings 621 and 622 and a resistance value between the detection wirings 621B and 622B are different from each other. Accordingly, it is preferable that a threshold value for estimating the degree of deterioration of the first bonding portion GL1Ae and a threshold value for estimating the degree of deterioration of the first bonding portion GL1C are different from each other. Hereinafter, the threshold value for estimating the degree of deterioration of the first bonding portion GL1Ae is referred to as a “first threshold value”, and the threshold value for estimating the degree of deterioration of the first bonding portion GL1C is referred to as a “second threshold value”. When the current value of the detection mechanism 60Ae is less than the first threshold value, the estimation section 73e estimates that the states of the first bonding portions GL1Ae and GL1C are the non-deteriorated state. Additionally, when the current value of the detection mechanism 60Ae is equal to or greater than the first threshold value, and the current value of the detection mechanism 60B is less than the second threshold value, the estimation section 73e estimates that the state of the first bonding portion GL1Ae is the deteriorated state, and the state of the first bonding portion GL1C is the non-deteriorated state. Further, when the current value of the detection mechanism 60B is equal to or greater than the second threshold value, the estimation section 73e estimates that each state of the first bonding portions GL1Ae and GL1C is the deteriorated state.

The notification section 75e generates the notification information CI in the third modification example based on the estimation result of the estimation section 73e and notifies the user U of the notification information CI in the third modification example. The notification information CI in the third modification example is information regarding the liquid ejecting head 30e having a sign of ink leakage. However, the notification information CI in the third modification example includes information indicating a degree of a sign of ink leakage from the liquid ejecting head 30e. For example, when the estimation section 73e estimates that the state of the first bonding portion GL1Ae is the deteriorated state and the state of the first bonding portion GL1C is the non-deteriorated state, the notification information CI is a first sign character string indicating a first-stage sign of ink leakage from the liquid ejecting head 30e. The first sign character string is a character string stating “There is a sign of ink leakage in the liquid ejecting head. Please consider replacing the liquid ejecting head”. In addition, when the estimation section 73e estimates that each state of the first bonding portions GL1Ae and GL1C of the liquid ejecting head 30e is the deteriorated state, the notification information CI is a second sign character string indicating a second-stage sign of ink leakage from the liquid ejecting head 30e. The second-stage sign of ink leakage from the liquid ejecting head 30e has a shorter period until ink leaks than the first-stage sign of ink leakage from the liquid ejecting head 30e. The second sign character string is a character string stating “A sign of ink leakage from the liquid ejecting head is increased. It is recommended to replace the liquid ejecting head”.

As described above, the liquid ejecting head 30e in the third modification example further includes the first bonding portion GL1C that is disposed between the first bonding portions GL1Ae and GL1Be and that is provided to surround the first bonding portion GL1Ae, and the conductive wire portion 613B for detecting a state in which ink passes beyond the first bonding portion GL1C but does not pass beyond the first bonding portion GL1Be, and the conductive wire portion 613Ae is provided to detect a state in which ink passes beyond the first bonding portion GL1Ae but does not pass beyond the first bonding portion GL1C.

According to the third modification example, a sign of ink leakage from the liquid ejecting head 30e can be detected in multiple stages. The user U can take measures corresponding to each piece of notification information CI. Specifically, the user U can use the liquid ejecting head 30e until immediately before the liquid ejecting head 30e fails, while securing a period of time for preparing a replacement liquid ejecting head 30e. For example, when the user U is notified of the first sign character string as the notification information CI in the third modification example, the user U orders the liquid ejecting head 30e from the head manufacturer. Then, when the user U is notified of the second sign character string as the notification information CI in the third modification example, the user U replaces the liquid ejecting head 30e with the liquid ejecting head 30e acquired from the head manufacturer.

Although an aspect to which the third modification example is applied to the first embodiment is described, the third modification example can also be applied to each of the second embodiment and the third embodiment.

### 4-3. Fourth Modification Example

In the second embodiment, the first bonding portion GL1Ba is provided to be in close contact with the first bonding portion GL1A, but may be disposed with a spacing from the first bonding portion GL1A.

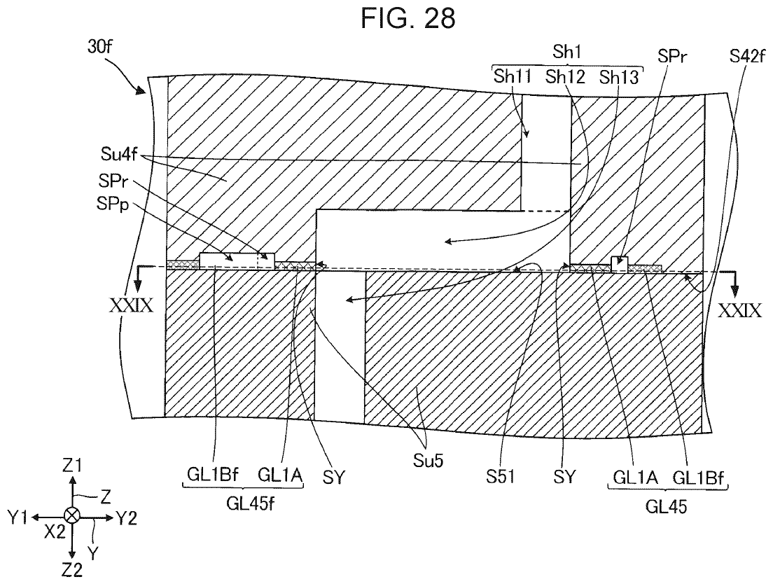

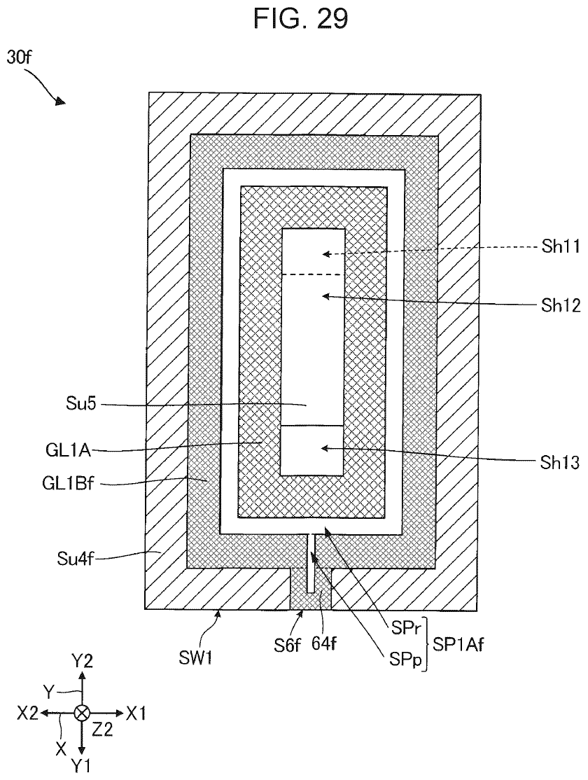

FIGS. 28 and 29 are views illustrating a first bonding portion GL1Bf in a fourth modification example. In FIG. 28, the region RG1 shown in FIG. 12 is shown in an enlarged manner with the liquid ejecting head 30 replaced with a liquid ejecting head 30f. FIG. 29 shows a cross-section of the liquid ejecting head 30f taken along line XXIX-XXIX shown in FIG. 28.

The liquid ejecting head 30f includes a flow path plate Su4f instead of the flow path plate Su4. A first space SP1Af is formed in the flow path plate Su4f by cutting out a surface S42f of the flow path plate Su4f in the Z1 direction. Therefore, the first space SP1Af is defined by the flow path plates Su4f and Su5.

A bonding portion GL45f in the fourth modification example includes the first bonding portion GL1Bf instead of the first bonding portion GL1Ba. The first bonding portion GL1Bf is provided to surround the first bonding portion GL1A with a spacing from the first bonding portion GL1A. An annular portion SPr, which is a part of the first space SP1Af, coincides with the spacing between the first bonding portion GL1Bf and the first bonding portion GL1A.

In the examples of FIGS. 28 and 29, the first bonding portion GL1Bf includes a projecting portion 64f protruding in the Y1 direction from an annular portion of the first bonding portion GL1Bf that surrounds the first bonding portion GL1A. The projecting portion 64f includes a detection surface S6f facing the Y1 direction. Similarly to the second embodiment, in the example of FIG. 29, the detection surface S6f is flush with a wall surface SW1 of the flow path structure 33 that faces the Y1 direction. However, the detection surface S6f need not be flush with the wall surface SW1 and may be recessed with respect to the wall surface SW1 to such an extent as to be visually recognizable from the outside of the flow path structure 33.

The first space SP1Af includes the annular portion SPr and a groove SPp protruding from the annular portion SPr in the Y1 direction. The groove SPp is formed by communication between a space formed by a cutout of the above-mentioned annular portion of the first bonding portion GL1Bf in the Y1 direction and a space formed by a recess of the projecting portion 64f in the Y1 direction. The groove SPp can guide ink from the first bonding portion GL1A toward the wall surface SW1, which is an outer surface of the flow path plate Su4f, more specifically, toward the detection surface S6f. The width of the groove SPp in the direction along the X-axis is, for example, a width on which a capillary force acts. Since the width of the groove SPp in the direction along the X-axis is the width on which the capillary force acts, the ink can be actively moved to the vicinity of the detection surface S6f.

In the fourth modification example, the flow path plate Su4f is an example of a “first flow path member”, the flow path plate Su5 is an example of a “second flow path member”, the first space SP1Af is an example of a “first region A”, and the detection surface S6f, which is a part of the first bonding portion GL1Bf, is an example of a “first detection portion A”.

Similarly to the second embodiment, the first bonding portion GL1Bf has a property of discoloring upon contact with ink.

As described above, according to the fourth modification example, the first bonding portion GL1Bf is disposed with a spacing from the first bonding portion GL1A, the flow path plates Su4f and Su5 define the first space SP1Af between the first bonding portions GL1A and GL1Bf, and the groove SPp capable of guiding ink from the first bonding portion GL1A toward the wall surface SW1 of the flow path plate Su4f is disposed in the first space SP1Af.

According to the fourth modification example, since ink is guided toward the outer surface of the flow path plate Su4f by the groove SPp, the supply flow path Sh1 itself need not be disposed in the vicinity of an outer wall of the flow path structure 33, thereby enabling securing of a degree of freedom in a layout of the supply flow path Sh1.

### 4-4. Fifth Modification Example

In the first embodiment, the first modification example based on the first embodiment, the second modification example based on the first embodiment, and the third modification example based on the first embodiment, the conductive wire portion 613 is a meandering wiring, but the present disclosure is not limited thereto.

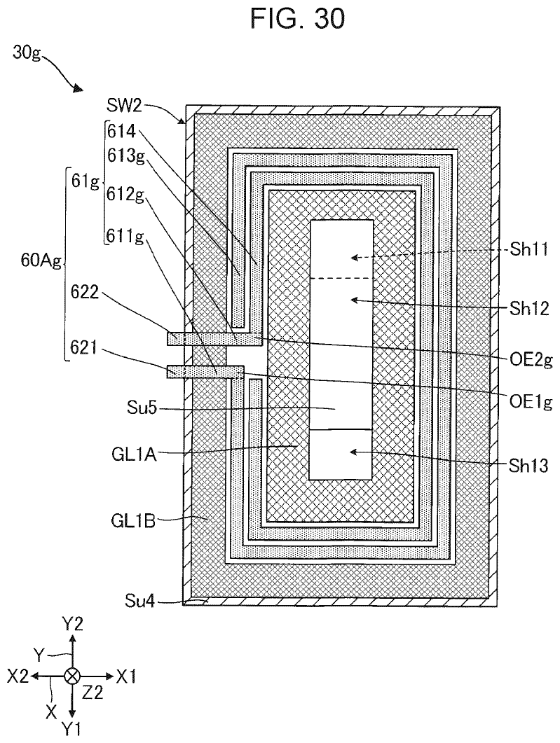

FIG. 30 is a view illustrating a detection mechanism 60Ag in a fifth modification example. FIG. 30 shows a cross-section of a liquid ejecting head 30g in the fifth modification example, taken along line a-a shown in FIG. 13. The liquid ejecting head 30g includes the detection mechanism 60Ag instead of the detection mechanism 60A.

The detection mechanism 60Ag includes a detection conductive wire 61g instead of the detection conductive wire 61. The detection conductive wire 61g includes conductive wire portions 611g, 612g, and 613g and a conductive wire portion 614. The conductive wire portion 611g is coupled to one end OE1g of the conductive wire portion 613g at an end portion in the X1 direction. The conductive wire portion 612g is coupled to one end OE2g of the conductive wire portion 614 at an end portion in the X1 direction.

The conductive wire portions 613g and 614 are each formed in C-shape obtained by cutting out a part of a circle and have a cutout in the X2 direction. As understood from FIG. 30, the conductive wire portion 614 is disposed between the conductive wire portion 613g and the first bonding portion GL1A. In the fifth modification example, the conductive wire portions 613g and 614 are examples of a “first detection portion A” and examples of “one or more conductive wires disposed in the first region A between the first bonding portion A and the first bonding portion B”.

The measurement circuit 29 in the fifth modification example measures a current value between the detection wirings 621 and 622. In the initial state of the liquid ejecting head 30g, the detection wirings 621 and 622 are in a non-conductive state, and the current value is substantially zero. On the other hand, when ink leaks from the first bonding portion GL1A, the detection wirings 621 and 622 are electrically coupled by the ink, so that the current value between the detection wirings 621 and 622 is greater than zero.

### 4-5. Sixth Modification Example

In the first embodiment, the width L1B of the first bonding portion GL1B is narrower than the width L1A of the first bonding portion GL1A, but the width L1B may be wider than the width L1A.

### 4-6. Seventh Modification Example

In each of the aspects mentioned above, the control circuit 21 functions as the acquisition section 71, the estimation section 73, and the notification section 75, but may function as the acquisition section 71 and the estimation section 73 without functioning as the notification section 75. For example, when a service support staff member of the head manufacturer visits the printer manufacturer or the user U and executes the series of processes shown in FIG. 17, the control circuit 21 need not function as the notification section 75. The service support staff member provides appropriate support based on the estimation result of the degree of deterioration of the first bonding portion GL1A. For example, when the estimation result of the degree of deterioration of the first bonding portion GL1A indicates that the state of the first bonding portion GL1A is the deteriorated state, the service support staff member may propose replacement of the liquid ejecting head 30 to the user U.

What is claimed is:

1. A liquid ejecting head comprising:
a plurality of nozzles configured to eject liquid;
a first flow path that communicates with one or more nozzles among the plurality of nozzles;
a first bonding portion A that defines an inner wall of the first flow path and that is provided to surround the first flow path;
a first bonding portion B that is provided to surround the first bonding portion A; and
a first detection portion A for detecting a state in which the liquid passes beyond the first bonding portion A but does not pass beyond the first bonding portion B.

2. The liquid ejecting head according to claim 1, further comprising:
a second flow path that is different from the first flow path and that communicates with one or more nozzles among the plurality of nozzles; and
a second bonding portion A that defines an inner wall of the second flow path and that is provided to surround the second flow path, wherein
the first detection portion A is provided to detect a state in which the liquid passes beyond at least one of the first bonding portion A and the second bonding portion A but does not pass beyond the first bonding portion B, and
the first bonding portion B is provided to surround the first bonding portion A and the second bonding portion A with a spacing from the first bonding portion A and the second bonding portion A.

3. The liquid ejecting head according to claim 1, further comprising:
a second flow path that is different from the first flow path and that communicates with one or more nozzles among the plurality of nozzles;
a second bonding portion A that defines an inner wall of the second flow path and that is provided to surround the second flow path;
a second bonding portion B that is provided to surround the second bonding portion A with a spacing from the second bonding portion A; and
a second detection portion for detecting a state in which the liquid passes beyond the second bonding portion A but does not pass beyond the second bonding portion B.

4. The liquid ejecting head according to claim 1, further comprising:
a first bonding portion C that is disposed between the first bonding portion A and the first bonding portion B and that is provided to surround the first bonding portion A; and
a first detection portion B for detecting a state in which the liquid passes beyond the first bonding portion C but does not pass beyond the first bonding portion B, wherein
the first detection portion A is provided to detect a state in which the liquid passes beyond the first bonding portion A but does not pass beyond the first bonding portion C.

5. The liquid ejecting head according to claim 1, wherein
an adhesive forming the first bonding portion A and an adhesive forming the first bonding portion B are of the same type, and
a width of the first bonding portion B is narrower than a width of the first bonding portion A.

6. The liquid ejecting head according to claim 1, wherein
the first detection portion A is one or more conductive wires disposed in a first region A between the first bonding portion A and the first bonding portion B.

7. The liquid ejecting head according to claim 1, further comprising:
a flow path member that defines a first region A between the first bonding portion A and the first bonding portion B, wherein
the first detection portion A is a light-transmitting portion having light-transmitting properties, the light-transmitting portion being provided in the flow path member to make the first region A visually recognizable from an outside.

8. The liquid ejecting head according to claim 1, further comprising:
a first flow path member and a second flow path member that constitute the first flow path, wherein
the first bonding portion A and the first bonding portion B bond the first flow path member and the second flow path member,
a part of the first bonding portion B as the first detection portion A is disposed in a vicinity of an outer surface of the first flow path member, and
the first bonding portion B has a property of discoloring upon contact with liquid flowing through the first flow path.

9. The liquid ejecting head according to claim 8, wherein
the first bonding portion B is disposed with a spacing from the first bonding portion A,
the first flow path member and the second flow path member define a first region A between the first bonding portion A and the first bonding portion B, and
a groove configured to guide the liquid from the first bonding portion A toward the outer surface of the first flow path member is disposed in the first region A.

10. A liquid ejecting apparatus comprising:
the liquid ejecting head according to claim 1;
an acquisition section that acquires state information regarding a state of the first detection portion A; and
an estimation section that estimates a degree of deterioration of the first bonding portion A based on the state information.

11. The liquid ejecting apparatus according to claim 10, further comprising:
a notification section that issues a notification prompting replacement of the liquid ejecting head, based on an estimation result of the degree of deterioration of the first bonding portion A based on the state information.
